(19) United States
(12) Patent Application Publication
(10) Pub. No.: US 2024/0086609 A1
(43) Pub. Date: Mar. 14, 2024

(54) INTEGRATED CIRCUIT DESIGN METHOD, SYSTEM AND COMPUTER PROGRAM PRODUCT

(71) Applicant: TAIWAN SEMICONDUCTOR MANUFACTURING COMPANY, LTD., Hsinchu (TW)

(72) Inventors: Cheng-YU LIN, Hsinchu (TW); Chia Chun WU, Hsinchu (TW); Han-Chung CHANG, Hsinchu (TW); Chih-Liang CHEN, Hsinchu (TW)

(21) Appl. No.: 18/170,111

(22) Filed: Feb. 16, 2023

Related U.S. Application Data
(60) Provisional application No. 63/375,415, filed on Sep. 13, 2022.

(51) Int. Cl. G06F 30/392; G06F 30/398

(52) U.S. Cl. CPC G06F 30/392; G06F 30/398; G06F 2111/20

(57) ABSTRACT

A system including a processor configured to perform generating a plurality of different layout blocks; selecting, among the plurality of layout blocks, layout blocks corresponding to a plurality of blocks in a floorplan of a circuit; combining the selected layout blocks in accordance with the floorplan into a layout of the circuit; and storing the layout of the circuit in a cell library or using the layout of the circuit to generate a layout for an integrated circuit (IC) containing the circuit. Each of the plurality of layout blocks satisfies predetermined design rules and includes at least one of a plurality of different first block options associated with a first layout feature, and at least one of a plurality of different second block options associated with a second layout feature different from the first layout feature.

### RELATED APPLICATION(S)

The instant application claims the benefit of U.S. Provisional Application No. 63/375,415, filed Sep. 13, 2022, which is incorporated by reference herein in its entirety.

### BACKGROUND

An integrated circuit (“IC”) device includes one or more semiconductor devices represented in an IC layout (also referred to as “IC layout diagram”). A layout diagram is hierarchical and includes modules which carry out higher-level functions in accordance with the semiconductor device's design specifications. The modules are often built from a combination of cells, each of which represents one or more semiconductor structures configured to perform a specific function. Cells having pre-designed layout diagrams are stored in cell libraries (sometimes referred to as “libraries” for simplicity) and accessible by various tools, such as electronic design automation (EDA) tools, to generate, optimize and verify designs for ICs.

Layout diagrams are generated in a context of design rules. A set of design rules imposes constraints on the placement of corresponding patterns in a layout diagram, e.g., geographic/spatial restrictions, connectivity restrictions, or the like. Often, a set of design rules includes a subset of design rules pertaining to the spacing and other interactions between patterns in adjacent or abutting cells where the patterns represent conductors in a layer of metallization. Routing is where the different devices in a device are connected.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a block diagram of an IC device, in accordance with some embodiments.

FIG. 1B is a functional flow chart of at least a portion of an IC design flow in accordance with some embodiments.

FIG. 2 is a schematic circuit diagram of a circuit of an IC device, in accordance with some embodiments.

FIGS. 3A, 3C, 3D are schematic views at various layers of a layout diagram of a circuit of an IC device, in accordance with some embodiments. FIG. 3B is a schematic diagram of a floorplan of the circuit, in accordance with some embodiments.

FIG. 3E is a schematic cross-sectional view of an IC device, in accordance with some embodiments.

FIGS. 4A, 4B are schematic views showing various block options associated with corresponding layout features, in accordance with some embodiments.

FIG. 4C includes schematic views showing example combinations of block options associated with corresponding layout features, in accordance with some embodiments.

FIGS. 4D, 4E are schematic views showing various block options associated with a further layout feature, in accordance with some embodiments.

FIG. 4F includes schematic views showing example combinations of block options associated with corresponding layout features, in accordance with some embodiments.

FIG. 5A is a schematic view showing an example of mapping block options associated with a layout feature to a floorplan of a circuit of an IC device, in accordance with some embodiments.

FIG. 5B is a schematic view showing an example result of mapping various layout blocks to a floorplan of a circuit of an IC device, and FIG. 5C is a schematic view of a layout diagram obtained by combining the various layout blocks, in accordance with some embodiments.

FIG. 5D includes a schematic view showing an example of mapping various layout blocks to a floorplan of a circuit of an IC device, and a schematic view of a layout diagram obtained by combining the various layout blocks, in accordance with some embodiments.

FIG. 6 is a schematic view showing a search for combining various layout blocks mapped to a floorplan of a circuit of an IC device into various layout diagrams of the circuit, in accordance with some embodiments.

FIG. 7A is a schematic view showing a potential design rule violation when certain layout blocks are combined.

FIGS. 7B-7D are schematic views showing various examples of combining layout blocks, in accordance with some embodiments.

FIG. 8A-8D are flow charts of various methods, in accordance with some embodiments.

FIG. 9 is a block diagram of an electronic design automation (EDA) system, in accordance with some embodiments.

FIG. 10 is a block diagram of an IC manufacturing system and an IC manufacturing flow associated therewith, in accordance with some embodiments.

### DETAILED DESCRIPTION

The following disclosure provides many different embodiments, or examples, for implementing different features of the provided subject matter. Specific examples of components, materials, values, steps, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Source/drain(s) may refer to a source or a drain, individually or collectively dependent upon the context.

In an integrated circuit (IC) design process, a design of an IC device is provided by a circuit designer. An IC layout of the IC device is generated based on the design, e.g., by a placement and routing operation. Various checks and/or simulations are performed for the generated IC layout. When one or more of the checks or simulations indicate one or more yield and/or performance concerns, the IC layout is modified. An approach for modifying an IC layout is to change a current layout of a circuit in the IC layout to another layout of the same circuit. Various design considerations, such as power, performance, area (PPA) may differ, sometimes hugely, from one layout (or layout solution) of a circuit to another layout of the same circuit.

Some embodiments provide multiple, different layouts (or layout solutions) of a circuit, e.g., in one or more cell libraries. In at least one embodiment, it is possible to find, among the provided multiple different layouts, a better layout than the current layout, depending on the particular PPA concern(s) of the current layout. Some embodiments provide an exhaustive search for all possible layouts of a circuit, for a given layout configuration. With all possible layouts of the circuit being identified for a given layout configuration, the likelihood of being able to find a better layout than the current layout is increased, making it possible to improve IC layouts in one or more embodiments.

In some embodiments, a method to find multiple, or all possible, layouts of a circuit comprises generating layout blocks, mapping some of the generated layout blocks with a floorplan of the circuit, and combining the mapped (or selected) layout blocks into a layout of the circuit. In at least one embodiment, the generated layout blocks satisfy predetermined design rules, and are sometimes referred to as design-rule-check (DRC)-free (i.e., the generated layout blocks do not cause a DRC violation when a DRC is executed). In at least one embodiment, the mapping of some of the generated layout blocks with the floorplan of the circuit is performed in a manner that satisfies predetermined layout-versus-schematic (LVS) rules, and is sometimes referred to as LVS-free. In at least one embodiment, the combining the mapped (or selected) layout blocks into a layout of the circuit is performed in a manner that is substantially DRC-free, and is sometimes referred to as DRC-less (i.e., less likely to cause a DRC violation when a DRC is executed). Because various stages in the process of generating layouts of a circuit are DRC-free, LVS-free or DRC-less, the likelihood that the generated layouts may cause IC layouts containing the generated layouts to fail a DRC or LVS check is low, thereby improving the efficiency of the IC design process, in one or more embodiments.

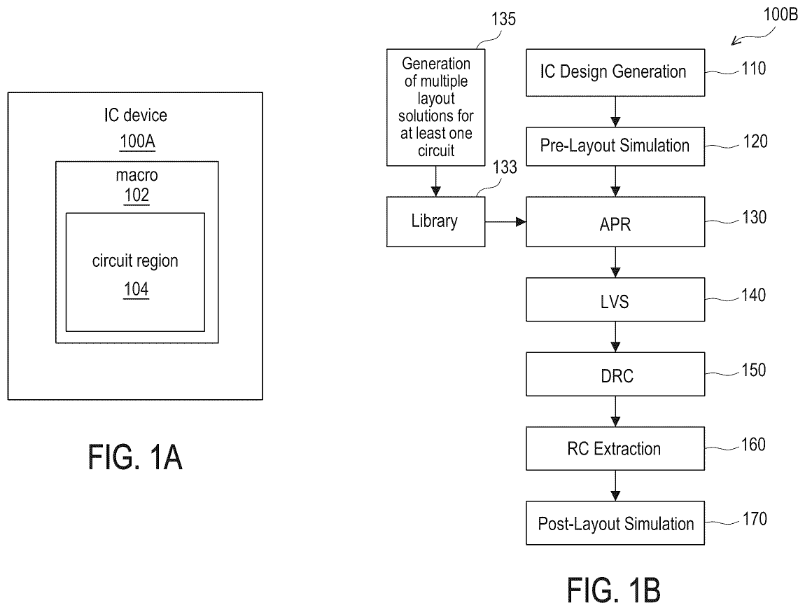

FIG. 1A is a block diagram of an IC device 100A, in accordance with some embodiments.

In FIG. 1, the IC device 100A comprises, among other things, a macro 102. In some embodiments, the macro 102 comprises one or more of a memory, a power grid, a cell or cells, an inverter, a latch, a buffer and/or any other type of circuit arrangement that may be represented digitally in a cell library. In some embodiments, the macro 102 is understood in the context of an analogy to the architectural hierarchy of modular programming in which subroutines/procedures are called by a main program (or by other subroutines) to carry out a given computational function. In this context, the IC device 100A uses the macro 102 to perform one or more given functions. Accordingly, in this context and in terms of architectural hierarchy, the IC device 100A is analogous to the main program and the macro 102 is analogous to subroutines/procedures. In some embodiments, the macro 102 is a soft macro. In some embodiments, the macro 102 is a hard macro. In some embodiments, the macro 102 is a soft macro which is described digitally in register-transfer level (RTL) code. In some embodiments, synthesis, placement and routing have yet to have been performed on the macro 102 such that the soft macro can be synthesized, placed and routed for a variety of process nodes. In some embodiments, the macro 102 is a hard macro which is described digitally in a binary file format (e.g., Graphic Database System II (GDSII) stream format), where the binary file format represents planar geometric shapes, text labels, other information and the like of one or more layout-diagrams of the macro 102 in hierarchical form. In some embodiments, synthesis, placement and routing have been performed on the macro 102 such that the hard macro is specific to a particular process node.

The macro 102 includes a circuit region 104 which comprises at least one layout for a circuit generated in accordance with some embodiments as described herein. In some embodiments, the circuit region 104 comprises a substrate having circuitry formed thereon, in a front-end-of-line (FEOL) fabrication. Furthermore, above and/or below the substrate, the circuit region 104 comprises various metal layers that are stacked over and/or under insulating layers in a Back End of Line (BEOL) fabrication. The BEOL provides a power network and/or routing for circuitry of the IC device 100A, including the macro 102 and the circuit region 104.

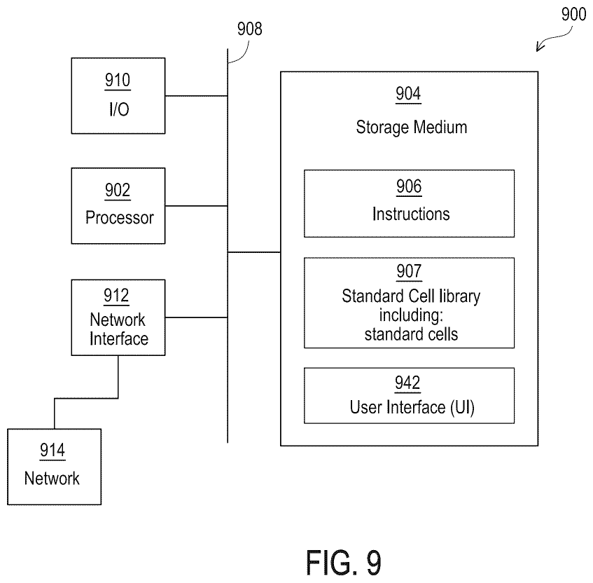

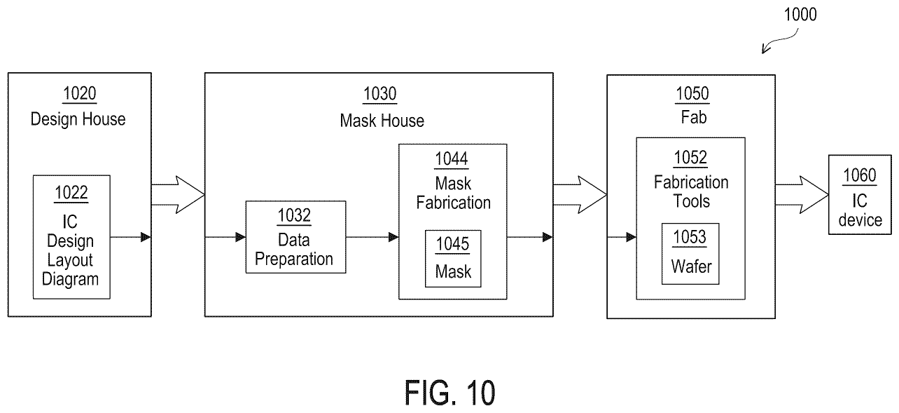

FIG. 1B is a functional flow chart of at least a portion of an IC design flow 100B in accordance with some embodiments. In at least one embodiment, the design flow 100B utilizes one or more electronic design automation (EDA) tools for testing a design of an IC before manufacturing the IC. The EDA tools, in some embodiments, are one or more sets of executable instructions for execution by a processor or controller or a programmed computer to perform the indicated functionality. In at least one embodiment, the IC design flow 100B is performed by a design house of an IC manufacturing system discussed herein with respect to FIGS. 9-10. In some embodiments, the IC design flow 100B is performed to design an IC layout for the IC device 100A.

At operation 110, a design of an IC is provided by a circuit designer. In some embodiments, the design of the IC includes an IC schematic, i.e., an electrical diagram, of the IC. In some embodiments, the schematic is generated or provided in the form of a schematic netlist, such as a Simulation Program with Integrated Circuit Emphasis (SPICE) netlist. Other data formats for describing the design are usable in some embodiments.

At operation 120, a pre-layout simulation is performed, e.g., by an EDA tool, on the design to determine whether the design meets a predetermined specification. If the design does not meet the predetermined specification, the IC is redesigned. In some embodiments, a SPICE simulation is performed on the SPICE netlist. Other simulation tools are usable, in place of or in addition to the SPICE simulation, in other embodiments.

At operation 130, a layout (or layout diagram) of the IC is generated based on the design. The IC layout diagram comprises the physical positions of various circuit elements (or devices) of the IC as well as the physical positions of various nets and vias interconnecting the circuit elements. In some embodiments, the IC layout is generated in the form of a Graphic Design System (GDS) file by an EDA tool. Other data formats for describing the layout of the IC are within the scope of various embodiments.

In some embodiments, the IC layout diagram is generated at operation 130 by an EDA tool, such as an Automatic Placement and Routing (APR) tool. The APR tool receives the design of the IC in the form of a netlist as described herein, and performs a placement operation (or placement). For example, cells configured to provide pre-defined functions and having pre-designed layouts are stored in at least one library 133. In some embodiments, the at least one library 133 is stored in at least one non-transitory computer-readable medium. The APR tool accesses various cells from the at least one library 133, and places the cells in an abutting manner to generate an IC layout corresponding to the IC schematic. Example cells include, but are not limited to, inverters, adders, multipliers, logic gates, phase lock loops (PLLs), flip-flops, multiplexers, memory cells, combinations thereof, or the like. Example logic gates include, but are not limited to, an AND, OR, NAND, NOR, XOR, INV, AND-OR-Invert (AOI), OR-AND-Invert (OAI), MUX, Flip-flop, BUFF, Latch, delay, clock cells, or the like. In some embodiments, a cell includes one or more active or passive circuit elements. Examples of active elements include, but are not limited to, transistors and diodes. Examples of transistors include, but are not limited to, metal oxide semiconductor field effect transistors (MOSFET), complementary metal oxide semiconductor (CMOS) transistors, bipolar junction transistors (BJT), high voltage transistors, high frequency transistors, p-channel and/or n-channel field effect transistors (PFETs/NFETs), FinFETs, planar MOS transistors with raised source/drain, or the like. Examples of passive elements include, but are not limited to, capacitors, inductors, fuses, and resistors.

The APR tool then performs a routing operation (or routing) to route various nets and vias interconnecting the placed circuit elements. Examples of nets include, but are not limited to, conductive pads, conductive patterns, and conductive redistribution layers, or the like. The routing operation is performed to ensure that the routed interconnections satisfy a set of constraints. After the routing operation, the APR tool outputs the IC layout diagram including the placed circuit elements and the routed nets and vias. Nets and vias are commonly referred to herein as routing features. The described APR tool is an example. Other arrangements are within the scope of various embodiments. For example, in one or more embodiments, one or more of the described operations are omitted.

At operation 135, multiple layouts (or layout solutions) are generated for at least one circuit, as described herein with respect to various embodiments. The generated multiple layouts for the at least one circuit are stored in the at least one library 133. In some embodiments, the at least one library 133 stores multiple layouts generated at operation 135 for each circuit (or cell) among a plurality of circuits (or cells). Accordingly, the at least one library 133 provides various layout solutions of each cell for a designer to choose from, thereby permitting the designer to pick a layout best suitable for the particular IC being designed, and/or to revise the IC being designed to meet various requirements, such as PPA, timing, frequency, combination performance (e.g., frequency and power), low leakage concern, circuit robustness, constrained metal routing usage, or the like. In the example configuration in FIG. 1B, operation 135 is included as part of the design flow 100B. In some embodiments, operation 135 is a separate process from the design flow 100B, and provides multiple layouts of each cell in the at least one library 133 for use in the design flow 100B.

At operation 140, a layout-versus-schematic (LVS) check, is performed. The LVS check is performed to ensure that the generated IC layout corresponds to the design. Specifically, an LVS checking tool, i.e., an EDA tool, recognizes electrical components as well as connections therebetween from the patterns of the generated IC layout. The LVS checking tool then generates a layout netlist representing the recognized electrical components and connections. The layout netlist generated from the IC layout is compared, by the LVS checking tool, with the schematic netlist of the design. If the two netlists match within a matching tolerance, the LVS check is passed. Otherwise, correction is made to at least one of the IC layout or the design by returning the process to operation 110 and/or operation 130. Other verification processes are usable in some embodiments. In some embodiments, one or more LVS rules used in, or similar to those used in, an LVS check are used in operation 135, as described herein.

At operation 150, a design rule check (DRC) is performed, e.g., by an EDA tool, on the GDS file representing the IC layout, to ensure that the IC layout satisfies certain manufacturing design rules, i.e., to ensure manufacturability of the IC. If one or more design rules is/are violated, correction is made to at least one of the IC layout or the design by returning the process to operation 110 and/or operation 130. Examples of design rules include, but are not limited to, a width rule which specifies a minimum width of a pattern in the IC layout, a spacing rule which specifies a minimum spacing between adjacent patterns in the IC layout, an area rule which specifies a minimum area of a pattern in the IC layout, a metal-to-via spacing rule which specifies a minimum spacing between a metal pattern and an adjacent via, a metal-to-metal spacing rule, a polysilicon-to-oxide definition (PO-to-OD) spacing rule, a PO-to-PO spacing rule, or the like. Other verification processes are usable in some embodiments. In some embodiments, one or more design rules used in a DRC are used in operation 135, as described herein.

At operation 160, a resistance and capacitance (RC) extraction is performed, e.g., by an EDA tool, to determine parasitic parameters, e.g., parasitic resistance and parasitic capacitance, of interconnects in the IC layout for timing simulations in a subsequent operation. Other verification processes are usable in some embodiments.

At operation 170, a post-layout simulation is performed by a simulation tool, i.e., an EDA tool, to determine, taking the extracted parasitic parameters into account, whether the IC layout meets a predetermined specification. If the simulation indicates that the IC layout does not meet the predetermined specification, e.g., if the parasitic parameters cause undesirable delays, correction is made to at least one of the IC layout or the design by returning the process to operation 110 and/or operation 130. Otherwise, the IC layout is passed to manufacture or additional verification processes.

In some embodiments, one or more evaluations, checks and/or simulations indicate one or more yield and/or performance concerns, and a determination is made to modify the IC layout, e.g., by returning the process to operation 130. An approach for modifying the IC layout is to replace a current layout of a circuit in the IC layout with another layout of the same circuit obtained from the at least one library 133. Because multiple layouts of the circuit are available from the at least one library 133, the likelihood of being able to find a better layout than the current layout is increased, which makes it possible to successfully modify the IC layout to address one or more concerns in an efficient manner, in accordance with some embodiments. The modified IC layout is subjected to one or more checks and/or simulations, for example, as described with respect to operations 140-170. When the modified IC layout does not meet one or more requirements at operations 140-170, the process is returned to operation 130 for further layout modifications, with subsequent checks and verifications as described herein. In some embodiments, the IC layout before modification and/or the modified IC layout and/or the final IC layout for manufacture are stored in a non-transitory computer-readable medium.

In some embodiments, one or more of the described operations are omitted. In an example, one or more of the pre-layout simulation in operation 120, the RC extraction in operation 160, and the post-layout simulation in operation 170 is/are omitted, in one or more embodiments. Other arrangements are within the scopes of various embodiments. For simplicity, various operations and/or determinations are described herein as being performed by an APR tool. However, in at least one embodiment, one or more of the described operations and/or determinations are performed outside an APR tool, e.g., by one or more further automated systems, one or more processors, and/or one or more computer systems.

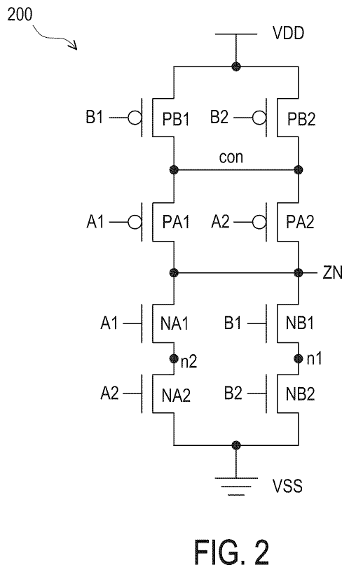

FIG. 2 is a schematic circuit diagram of a circuit 200, in accordance with some embodiments. In at least one embodiment, the circuit 200 corresponds to a portion of the region 104 in FIG. 1A and/or corresponds to a circuit for which multiple layouts are generated in operation 135 in FIG. 1B. In the example configuration in FIG. 2, the circuit 200 comprises an AND-OR-Invert (AOI) logic with two 2-input AND gates corresponding to a cell sometimes referred to as an AOI22D1 cell. Other example circuits or cells included in the region 104 and/or subjected to operation 135 include, but are not limited to, AND, OR, NAND, NOR, XOR, INV, OR-AND-Invert (OAI), MUX, Flip-flop, BUFF, Latch, delay, clock, memory, combinations thereof, or the like.

The circuit 200 comprises inputs A1, A2, B1, B2, an output ZN, and a plurality of transistors PA1, PA2, PB1, PB2, NA1, NA2, NB1, NB2 electrically coupled together to perform, in operation, a predetermined function of the circuit 200. Examples of transistors in the circuit 200 include, but are not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like. In the example configuration in FIG. 2, the circuit 200 comprises PMOS transistors PA1, PA2, PB1, PB2 and NMOS transistors NA1, NA2, NB1, NB2.

Gates of the transistors PA1, NA1 are electrically coupled to the input A1. Gates of the transistors PA2, NA2 are electrically coupled to the input A2. Gates of the transistors PB1, NB1 are electrically coupled to the input B1. Gates of the transistors PB2, NB2 are electrically coupled to the input B2.

Sources of the transistors PB1, PB2 are electrically coupled to a first node (or rail) of a first power supply voltage. The first node (or rail) and the first power supply voltage are commonly referred to herein as VDD. Drains of the transistors PB1, PB2 are electrically coupled to a net con. As a result, the transistors PB1, PB2 are electrically coupled in parallel between VDD and the net con. Sources of the transistors PA1, PA2 are electrically coupled to the net con. Drains of the transistors PA1, PA2 are electrically coupled to the output ZN. As a result, the transistors PA1, PA2 are electrically coupled in parallel between the net con and the output ZN. The parallel coupled transistors PB1, PB2 and the parallel coupled transistors PA1, PA2 are electrically coupled in series at the net con.

Sources of the transistors NA2, NB2 are electrically coupled to a second node (or rail) of a second power supply voltage. The second node (or rail) and the second power supply voltage are commonly referred to herein as VSS (or ground). A drain of the transistor NA2 is electrically coupled to a source of the transistor NA1 at a net n2. As a result, the transistors NA1, NA2 are electrically coupled in series. A drain of the transistor NB2 is electrically coupled to a source of the transistor NB1 at a net n1. As a result, the transistors NB1, NB2 are electrically coupled in series. Drains of the transistors NA1, NB1 are electrically coupled to the output ZN. As a result, the serially coupled transistors NA1, NA2 and the serially coupled transistors NB1, NB2 are coupled in parallel between the output ZN and VSS. The described VDD, VSS, A1, A2, B1, B2, ZN, net n1, net n2, and net con are examples of various nets in a floorplan of a circuit, as described herein.

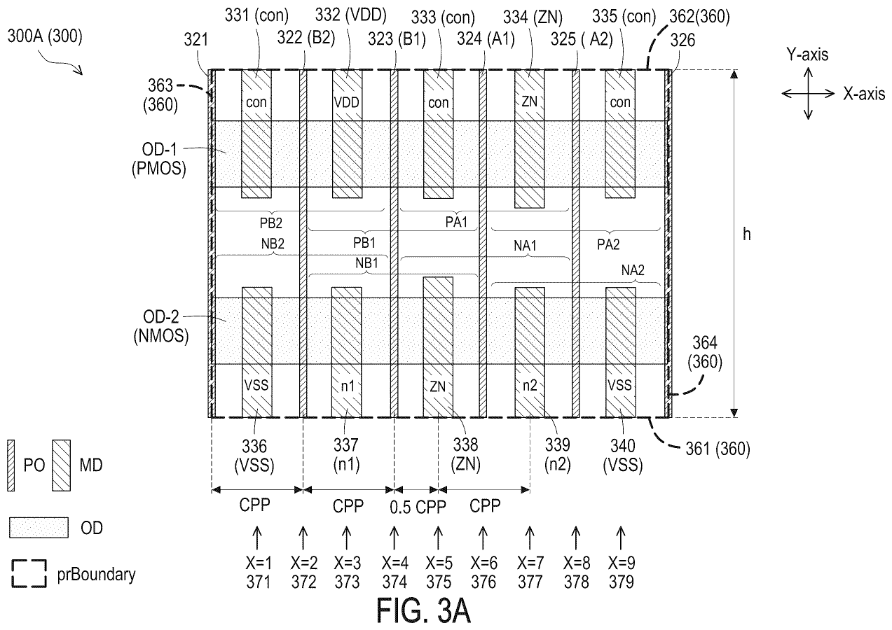

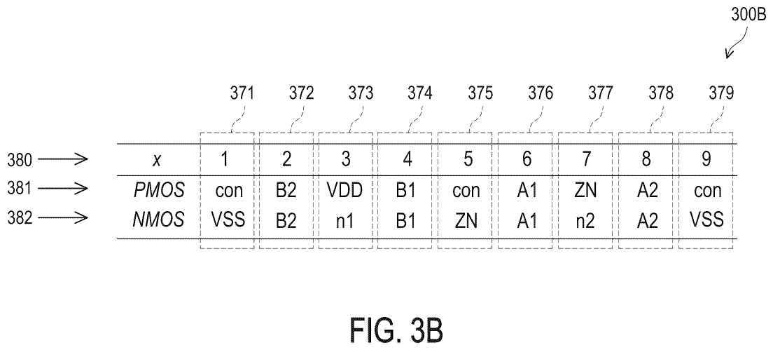

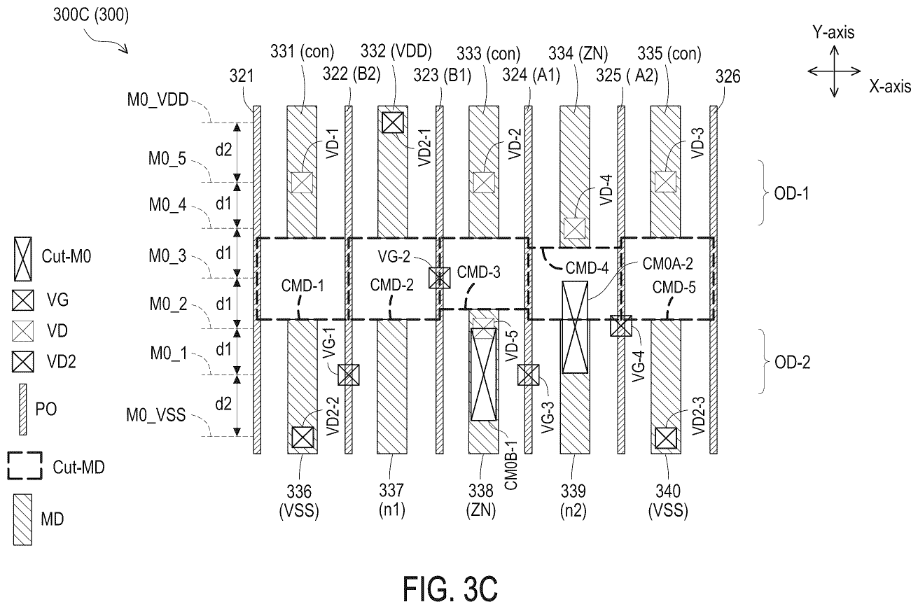

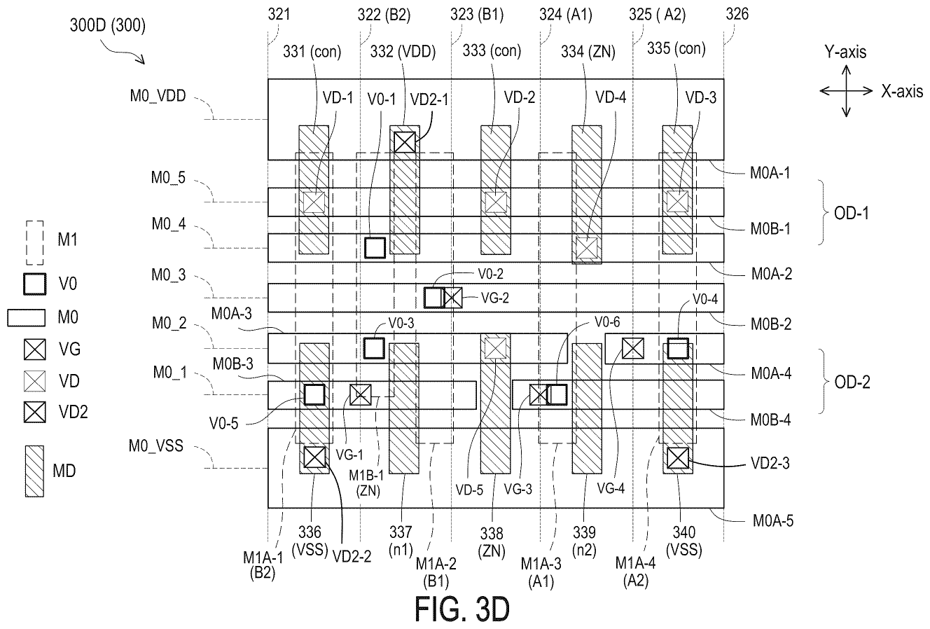

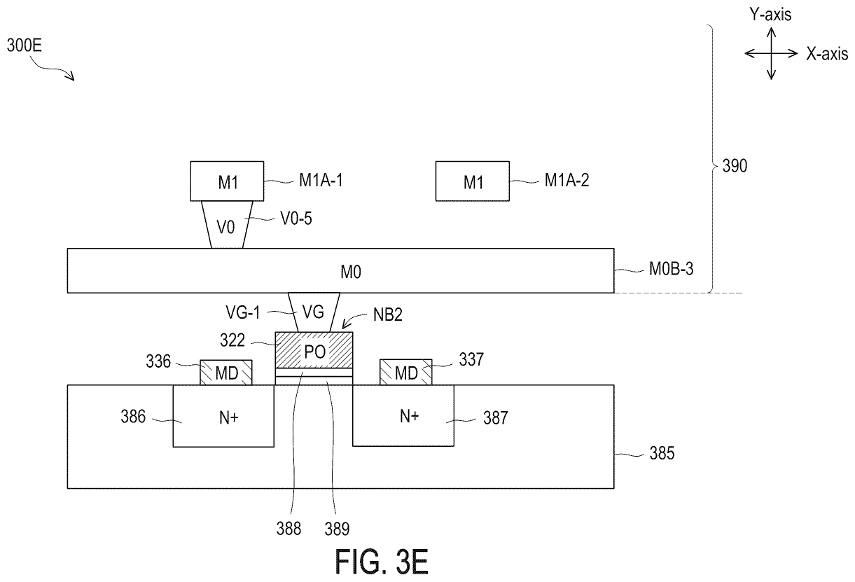

FIG. 3A is a schematic view of a layout 300A which includes several layers of a layout 300 of the circuit 200, in accordance with some embodiments. Corresponding elements of the circuit 200 and the layout 300 are designated by the same reference numerals.

As shown in FIG. 3A, the layout 300 comprises a plurality of active regions OD-1, OD-2. Active regions are sometimes referred to as oxide-definition (OD) regions or source/drain regions, and are schematically illustrated in the drawings with the label “OD.” The active regions OD-1, OD-2 are elongated along a first axis, e.g., the X-axis. The active regions OD-1, OD-2 include P-type dopants and/or N-type dopants to form one or more circuit elements or devices. An active region configured to form one or more PMOS devices is sometimes referred to as “PMOS active region,” and an active region configured to form one or more NMOS devices is sometimes referred to as “NMOS active region.” In the example configuration described with respect to FIG. 3A, the active region OD-1 comprises a PMOS active region, and the active region OD-2 comprise an NMOS active region. Other configurations are within the scopes of various embodiments.

The layout 300 further comprises a plurality of gate regions 321, 322, 323, 324, 325, 326 over the active regions OD-1, OD-2. The gate regions 321, 322, 323, 324, 325, 326 are elongated along a second axis, e.g., the Y-axis, which is transverse to the X-axis. The gate regions 321, 322, 323, 324, 325, 326 are arranged along the X axis at a regular pitch designated at CPP (contacted poly pitch) in FIG. 3A. CPP is a center-to-center distance along the X axis between two immediately adjacent gate regions. Two gate regions are considered immediately adjacent where there are no other gate regions therebetween. A width (or cell pitch) of the layout 300 along the X axis is 5 CPP in the example configuration in FIG. 3A. The gate regions 321, 322, 323, 324, 325, 326, in a manufactured IC device corresponding to the layout 300, comprise a conductive material, such as, polysilicon, which is sometimes referred to as “poly.” The gate regions 321, 322, 323, 324, 325, 326 are schematically illustrated in the drawings with the label “PO.” Other conductive materials for the gate regions, such as metals, are within the scope of various embodiments. In the example configuration in FIG. 3A, the gate regions 322, 323, 324, 325 are functional gate regions which, together with the active regions OD-1, OD-2, configure a plurality of transistors as described herein. In some embodiments, the gate regions 321, 326 are non-functional, or dummy, gate regions. Dummy gate regions are not configured to form transistors together with underlying active regions, and/or one or more transistors formed by dummy gate regions together with the underlying active regions are not electrically coupled to other circuitry. In at least one embodiment, non-functional, or dummy, gate regions include dielectric material in a manufactured IC device.

In the example configuration in FIG. 3A, each of the gate regions 321, 322, 323, 324, 325, 326 extends continuously across the active regions OD-1, OD-2. In some embodiments, a gate region is cut, or divided, into several portions each over a corresponding active region. For example, in a layout for another circuit, the gate region 322 is cut, e.g., by a cut-poly (CPO) region described herein, into two gate region portions each over a corresponding one of the active regions OD-1, OD-2. For another example, in a layout for a further circuit with more than two active regions, a gate region is cut by multiple CPO regions into more than two portions over the more than two active regions.

The layout 300 further comprises a plurality of transistors configured by the gate regions 321, 322, 323, 324, 325, 326 and the active regions OD-1, OD-2. For example, the transistors PB2, PB1, PA1, PA2 are configured by the PMOS active region OD-1 together with the corresponding gate regions 322, 323, 324, 325. The transistors NB2, NB1, NA1, NA2 are configured by the NMOS active region OD-2 together with the corresponding gate regions 322, 323, 324, 325. The gate region 322 corresponds to the gates of the transistors PB2, NB2, and also corresponds to the input B2 of the circuit 200. The gate region 323 corresponds to the gates of the transistors PB1, NB1, and also corresponds to the input B1 of the circuit 200. The gate region 324 corresponds to the gates of the transistors PA1, NA1, and also corresponds to the input A1 of the circuit 200. The gate region 325 corresponds to the gates of the transistors PA2, NA2, and also corresponds to the input A2 of the circuit 200. Source/drains of the transistors PB2, PB1, PA1, PA2 correspond to portions of the active region OD-1 on opposite sides of the corresponding gate regions 322, 323, 324, 325. Source/drains of the transistors NB2, NB1, NA1, NA2 correspond to portions of the active region OD-2 on opposite sides of the corresponding gate regions 322, 323, 324, 325.

The layout 300 further comprises source/drain contact regions over the corresponding source/drains in the active regions OD-1, OD-2. Source/drain contact regions are sometimes referred to as metal-to-device (MD) regions, and are schematically illustrated in the drawings with the label “MD.” In a manufactured IC device corresponding to the layout 300, an MD region includes a conductive material, e.g., a metal, formed over a corresponding source/drain in the corresponding active region to define an electrical connection from one or more devices formed in the active region to other internal circuitry of the IC device or to outside circuitry. In the example configuration in FIG. 3A, MD regions 331, 332, 333, 334, 335 are over the active region OD-1, configured to define electrical contacts with the corresponding source/drains of the transistors PB2, PB1, PA1, PA2, and arranged alternatingly with the gate regions 321, 322, 323, 324, 325, 326 along the X-axis. A pitch, i.e., a center-to-center distance along the X axis, between immediately adjacent MD regions is the same as the pitch CPP between immediately adjacent gate regions. A center-to-center distance between a gate region (e.g., 323) and an immediately adjacent MD region (e.g., 338) is 0.5 CPP. MD regions 336, 337, 338, 339, 340 are over the active region OD-2, configured to define electrical contacts with the corresponding source/drains of the transistors NB2, NB1, NA1, NA2, and arranged alternatingly with the gate regions 321, 322, 323, 324, 325, 326 along the X-axis. Other configurations are within the scopes of various embodiments.

The MD regions 331, 333, 335 correspond to the net con in the circuit 200, and are to be electrically coupled together by one or more metal layers as described herein. The MD region 332 corresponds to VDD in the circuit 200. The MD regions 334, 338 correspond to the output ZN in the circuit 200, and are to be electrically coupled together by one or more metal layers as described herein. The MD regions 336, 340 correspond to VSS in the circuit 200, and are to be electrically coupled together by one or more metal layers as described herein. The MD region 337 corresponds to the net n1 in the circuit 200. The MD region 339 corresponds to the net n2 in the circuit 200.

The MD regions 331 and 336 are aligned with each other along the Y-axis, and are sometimes considered as two portions of an MD region that extends continuously across the active regions OD-1, OD-2, but is cut, or divided, by a cut-MD (CMD) region described herein, into the MD regions 331, 336 correspondingly over the active regions OD-1, OD-2. Similarly, each of the pairs of the MD regions 332 and 337, 333 and 338, 334 and 339, 335 and 340 is sometimes considered as two portions of an MD region that extends continuously across the active regions OD-1, OD-2, but is cut by a corresponding cut-MD (CMD) region. Other MD region configurations are within the scopes of various embodiments. For example, in a layout for another circuit, the MD regions 331 and 336 are contiguous to each other, and configure an MD region extending continuously over the active regions OD-1, OD-2. For another example, in a layout for a further circuit with more than two active regions, an MD region is cut by multiple CMD regions into mor than two portions over the more than two active regions.

The layout 300 further comprises a boundary (or cell boundary) 360 which comprises edges 361, 362, 363, 364. The edges 361, 362 are elongated along the X axis, and the edges 363, 364 are elongated along the Y axis. The edges 361, 362, 363, 364 are connected together to form the closed boundary 360. In a place-and-route operation (also referred to as “automated placement and routing (APR)”), cells are placed in an IC layout diagram in abutment with each other at their respective boundaries. The boundary 360 is sometimes referred to as “place-and-route boundary” and is schematically illustrated in the drawings with the label “prBoundary.” The rectangular shape of the boundary 360 is an example. Other boundary shapes for various cells are within the scope of various embodiments. The edges 361, 362 coincide with centerlines of corresponding M0 conductive patterns (not shown in FIG. 3A) as described herein. The edges 363, 364 coincide with centerlines of dummy or non-functional gate regions 321, 326. Between the edges 361, 362 and along the Y axis, the layout 300 contains one PMOS active region, i.e., OD-1, and one NMOS active region, i.e., OD-2, and is considered to have a height corresponding to one cell height h. Other configurations are within the scopes of various embodiments. For example, in one or more embodiments, another cell or circuit (not shown) containing along the Y axis two PMOS active regions and two NMOS active regions is considered to have a height corresponding to two cell heights, or double cell height, 2h. Cells or circuits with greater cell heights, e.g., 3h, 4h, or the like, are within the scopes of various embodiments.

The layout 300A in FIG. 3A shows a physical arrangement of a plurality of nets associated with a plurality of alternating gate blocks and source/drain blocks in a floorplan of the circuit 200. The floorplan in FIG. 3A comprises a plurality of blocks 371-379, including gate blocks 372, 374, 376, 378, and source/drain blocks 371, 373, 375, 377, 379. Each gate block comprises gate regions aligned with each other along the Y-axis. For example, the gate block 372 comprises the gate regions of the transistors PB2 and NB2 which are portions of the gate region 322 and are aligned with each other along the Y-axis. Each source/drain block comprises MD regions aligned with each other along the Y-axis. For example, the source/drain block 371 comprises the MD regions 331, 336 which are aligned with each other along the Y-axis. Each of the blocks 371-379 is identified by an X position of the block, in the floorplan, along the X-axis. For example, the source/drain block 371 is the first block (from the left) in the floorplan, and is identified by X=1. The gate block 372 is the second block in the floorplan, and is identified by X=2, or the like. Other manners for identifying the blocks in a floorplan are within the scopes of various embodiments.

As described herein, the nets con, B2, VDD, B1, con, A1, ZN, A2, con correspond to alternating MD regions and gate regions 331, 322, 332, 323, 333, 324, 334, 325, 335 over the PMOS active region OD1. The nets VSS, B2, n1, B1, ZN, A1, n2, A2, VSS correspond to alternating MD regions and gate regions 336, 322, 337, 323, 338, 324, 339, 325, 340 over the NMOS active region OD2. As a result, the source/drain block 371 which comprises the MD regions 331, 336 is associated with the corresponding nets con, VSS. Similarly, the gate block 372 is associated with the corresponding nets B2, B2. In some embodiments, it is possible that a block in a floorplan is associated with fewer than two nets, e.g., with one net or zero net. For example, when a gate region or an MD region is unused or non-functional, there is no net associated with the corresponding gate block or source/drain block. In some embodiments, it is possible that a block in a floorplan is associated with more than two nets. For example, in one or more embodiments, another cell or circuit (not shown) contains along the Y axis four active regions, e.g., two PMOS active regions and two NMOS active regions. In such a situation, a block of a floorplan of the cell or circuit is associated with four nets corresponding to the four active regions. Other configurations are within the scopes of various embodiments.

FIG. 3B is a schematic diagram of a floorplan 300B of the circuit 200, in accordance with some embodiments. The schematic diagram of the floorplan 300B in FIG. 3B corresponds to the physical arrangement of nets and associated blocks in the floorplan described with respect to FIG. 3A.

The floorplan 300B in FIG. 3B is schematically shown as a table having columns 371-379 corresponding to the blocks 371-379 described with respect to FIG. 3A, and rows 380-382 and. The row 380 indicates the X positions of the blocks 371-379, the row 381 indicates nets over the PMOS active region OD1 and associated with the blocks 371-379, and the row 382 indicates nets over the NMOS active region OD2 and associated with the blocks 371-379. For simplicity, the floorplan 300B is referred to in the subsequent description of various examples. Other manners for presenting a floorplan are within the scopes of various embodiments.

FIG. 3C is a schematic view of a layout 300C which includes further layers of the layout 300 of the circuit 200, in accordance with some embodiments. For simplicity, the active regions OD-1, OD-2 are schematically indicated by curly brackets (or braces) and the boundary 360 is omitted in FIG. 3C. In at least one embodiment, the layout 300C in FIG. 3C is one among multiple layouts generated at operation 135 in accordance with the floorplan 300B for the circuit 200, and stored in the at least one library 133 on a non-transitory computer-readable medium. In some embodiments, the layout in FIG. 3C is subsequently read from the at least one library 133, and placed at operation 130 into an IC layout of an actual IC to be designed and/or manufactured.

As shown in FIG. 3C, the layout 300 further comprises cut-MD regions CMD-1, CMD-2, CMD-3, CMD-4, CMD-5. In some embodiments, a cut-MD region is a mask, and corresponds to where an otherwise continuous MD region is disconnected. For example, the cut-MD region CMD-1 cuts, or divides an otherwise continuous MD region into the MD regions 331 and 336. Each cut-MD region has a pair of edges along the Y-axis, and correspondingly coinciding with the centerlines of a pair of adjacent gate regions. The size (width) of the cut-MD region along the X-axis is 1 CPP. For example, in FIG. 3C, left and right edges of the cut-MD region CMD-3 extend along the Y-axis and correspondingly coincide with the centerlines of the adjacent gate regions 323, 324. Other cut-MD region configurations are within the scopes of various embodiments. In some embodiments as described herein, a layout of another circuit comprises one or more cut-PO regions for cutting, or dividing, an otherwise continuous gate region into several gate region portions. A cut-PO region (e.g., a mask) corresponds to where the gate region is disconnected.

The layout 300 further comprises vias over the corresponding gate regions or MD regions. A via over a gate region is sometimes referred to as via-to-gate (VG) via. A via over an MD region is sometimes referred to as via-to-device (VD) via. VG and VD vias are schematically illustrated in the drawings with corresponding labels “VG” and “VD.” In the example configuration in FIG. 3C, vias VG-1, VG-2, VG-3, VG-4 are over the corresponding gate regions 322, 323, 324, 325. VD vias in FIG. 3C include VD vias for signals, and VD vias for power supply. The VD vias for signals include vias VD-1, VD-2, VD-3, VD-4, VD-5 which are over the corresponding MD regions 331, 333, 335, 334, 338 associated with signal nets con and ZN. The VD vias for power supply are schematically illustrated in the drawings with a label “VD2,” and include vias VD2-1, VD2-2, VD2-3 which are over the corresponding MD regions 332, 336, 340 associated with power supply nets VDD and VSS. In a manufactured IC device corresponding to the layout 300, VD vias and VG vias include a conductive material, e.g., a metal. Other vias configurations are within the scopes of various embodiments.

The VD vias and VG vias are configured to form electrical connections from the corresponding MD regions and gate regions to conductive patterns in an overlying metal layer, i.e., a metal-zero (M0) layer. Conductive patterns in the M0 layer are referred to herein as M0 conductive patterns. Example M0 conductive patterns of the layout 300 are described herein with respect to FIG. 3D. M0 conductive patterns are formed along one or more tracks M0_VSS, M0_1, M0_2, M0_3, M0_4, M0_5, M0_VDD extending along the X-axis, to ensure that predetermined design rules are satisfied. The tracks M0_VSS, M0_1, M0_2, M0_3, M0_4, M0_5, M0_VDD, or the like are also referred to herein as M0 tracks. The tracks M0_1, M0_2, M0_3, M0_4, M0_5 correspond to M0 conductive patterns configured to carry signals to, from or within the circuit 200. The tracks M0_1, M0_2, M0_3, M0_4, M0_5 are spaced from each other along the Y-axis, by a distance d1. The tracks M0_VSS, M0_VDD correspond to M0 conductive patterns configured to provide power supply to the circuit 200. The track M0_VSS is spaced along the Y-axis from the adjacent track M0_1 by a distance d2, and the track M0_VDD is spaced along the Y-axis from the adjacent track M0_5 by the distance d2. In the example configuration in FIG. 3C, d1<d2. Other configurations are within the scopes of various embodiments. The described number of five M0 tracks for signals and two M0 tracks for power supply is example. Other configurations are within the scopes of various embodiments.

As described with respect to FIG. 3D, M0 conductive patterns are arranged along the M0 tracks. To form electrical connections with overlying M0 conductive patterns, the VD vias and VG vias are also arranged along the M0 tracks. In the example configuration in FIG. 3C, the via VD2-1 is arranged along the track M0_VDD to form an electrical connection for receiving VDD, the vias VD-1, VD-2, VD-3 are arranged along the track M0_5, the via VD-4 is arranged along the track M0_4, the via VG-2 is arranged along the track M0_3, the vias VD-5, VG-4 are arranged along the track M0_2, the vias VG-1, VG-3 are arranged along the track M0_1, and the vias VD2-2, VD2-3 are arranged along the track M0_VSS to form an electrical connection for receiving VSS. A VD via is not arrangeable where there is a cut-MD region, i.e., where a underlying MD region does not exist. Likewise, a VG via is not arrangeable where there is a cut-PO region, i.e., where a underlying gate region does not exist. These are example rules to be observed and followed in designing or generating IC layouts.

The presence of multiple VD and/or VG vias associated with different nets along the same M0 track requires multiple corresponding M0 conductive patterns along the same M0 track. This is achieved by a cut-M0 (CM0) region, e.g., a mask, which corresponds to where an otherwise continuous M0 conductive pattern is disconnected, or divided into two separated M0 conductive patterns. For example, a cut-M0 region CM0A-2 is arranged between the via VD-5 (associated with the net ZN) and via VG-4 (associated with the net A2) along the same track M0_2, to configure two separated overlying M0 conductive patterns, as described with respect to FIG. 3D. For another example, a cut-M0 region CM0B-1 is arranged between the via VG-1 (associated with the net B2) and via VG-3 (associated with the net A1) along the same track M0_1, to configure two separated overlying M0 conductive patterns, as described with respect to FIG. 3D. However, when multiple vias associated with the same net are arranged along the same M0 track, it is possible to form an M0 conductive pattern over and connecting the multiple vias, and a cut-M0 region is not required. For example, although the vias VD-1, VD-2, VD-3 are arranged along the same track M0_5, no cut-M0 region is required because the vias VD-1, VD-2, VD-3 are all associated with the net con. For another example, although the vias VD2-2, VD2-3 are arranged along the same track M0_VSS, no cut-M0 region is required because the vias VD2-2, VD2-3 are all associated with the net VSS. These are further example rules to be observed and followed in designing or generating IC layouts.

FIG. 3D is a schematic view of a layout 300D which includes further layers of the layout 300 of the circuit 200, in accordance with some embodiments. For simplicity, in FIG. 3D, the active regions OD-1, OD-2 are schematically indicated by curly brackets (or braces), the gate regions 321-326 are schematically indicated by the corresponding centerlines, and the boundary 360, the cut-MD regions CMD-1, CMD-2, CMD-3, CMD-4, CMD-5, and the CM0 regions CM0A-2, CM0B-1 are omitted.

An IC layout comprising the layout 300 comprises a plurality of metal layers and via layers sequentially and alternatingly arranged over the VD and VG vias. The lowermost metal layer immediately over the VD and VG vias is the M0 layer, i.e., metal-zero (M0) layer. The M0 layer is the lowermost metal layer over, or the closest metal layer to, the active regions OD-1, OD-2. A next metal layer immediately over the M0 layer is the M1 layer, a next metal layer immediately over the M1 layer is the M2 layer, or the like. A via layer Vn is arranged between and electrically couple the Mn layer and the Mn+1 layer, where n is an integer form zero and up. For example, a via-zero (V0) layer is the lowermost via layer which is arranged between and electrically couple the M0 layer and the M1 layer. Other via layers are V1, V2, or the like.

In the example configuration in FIG. 3D, the layout 300 additionally comprises the M0 layer, V0 layer and M1 layer. An IC layout containing the layout 300 includes higher metal layers and/or via layers, which are omitted in FIG. 3D. In some embodiments, layouts of various cells or circuits include different sets of metal layers and via layers. For example, layouts of some cells include no metal layers. Layouts of other cells include no metal layers and no via layers higher than the M0 layer. Layouts of further cells include at least one metal layer and/or at least via layer higher than the M1 layer. Other configurations are within the scopes of various embodiments.

In the example configuration in FIG. 3D, the M0 conductive patterns in the layout 300 are separated into several masks to meet one or more design and/or manufacturing requirements. For example, the layout 300 further comprises conductive patterns M0A-1, M0A-2, M0A-3, M0A-4, M0A-5 corresponding to one M0 mask (referred to herein as the M0A mask), and conductive patterns M0B-1, M0B-2, M0B-3, M0B-4 corresponding to another M0 mask (referred to herein as the M0B mask). The M0A conductive patterns and M0B conductive patterns are arranged alternatingly along the Y-axis. For example, the conductive pattern M0B-1 is arranged between the conductive pattern M0A-1 on one side and the conductive patterns M0A-2 on the other side. The M0A conductive patterns are arranged along the tracks M0_VSS, M0_2, M0_4, M0_VDD. The M0B conductive patterns are arranged along the tracks M0_1, M0_3, M0_5. For example, centerlines of the M0A conductive patterns coincide with the corresponding tracks M0_VSS, M0_2, M0_4, M0_VDD, and centerlines of the M0B conductive patterns coincide with the corresponding tracks M0_1, M0_3, M0_5. The conductive patterns M0A-3, M0A-4 are arranged along the same track M0_2, and are separated from each other by a spacing corresponding to the cut-M0 region CM0A-2. The cut-M0 region CM0A-2 belongs to a cut-M0 mask CM0A configured to cut M0A conductive patterns. The conductive patterns M0B-3, M0B-4 are arranged along the same track M0_1, and are separated from each other by a spacing corresponding to the cut-M0 region CM0B-1. The cut-M0 region CM0B-1 belongs to a further cut-M0 mask CM0B configured to cut M0B conductive patterns. In some embodiments, all M0 conductive patterns in the M0 layer belong to the same mask, and all cut-M0 regions belong to the same cut-M0 mask. In some embodiments, M0 conductive patterns in the M0 layer belong to more than two masks, and cut-M0 regions correspondingly belong to more than two cut-M0 masks.

The conductive pattern M0A-1 is configured as a VDD power rail and is over the via VD2-1 to be electrically coupled to the MD region 332. The conductive pattern M0B-1 is over the vias VD-1, VD-2, VD-3, and electrically couples together the MD regions 331, 333, 335 corresponding the net con of the circuit 200. The conductive pattern M0A-2 is over the via VD-4, and is electrically coupled to the MD regions 334 corresponding the net ZN of the circuit 200. The conductive pattern M0B-2 is over the via VG-2, and is electrically coupled to the gate region 323. The conductive pattern M0A-3 is over the via VD-5, and is electrically coupled to the MD regions 338 corresponding the net ZN of the circuit 200. The conductive pattern M0A-4 is over the VG-4, and is electrically coupled to the gate region 325. The conductive pattern M0B-3 is over the VG-1, and is electrically coupled to the gate region 322. The conductive pattern M0B-4 is over the VG-3, and is electrically coupled to the gate region 324. The conductive pattern M0A-5 is configured as a VSS power rail and is over the vias VD2-2, VD2-3 to be electrically coupled to the MD regions 336, 340.

The layout 300 further comprises, in the V0 layer over the M0 layer, vias V0-1, V0-2, V0-3, V0-4, V0-5, V0-6 over the corresponding conductive patterns M0A-2, M0B-2, M0A-3, M0A-4, M0B-3, M0B-4, of the M0 layer. In the example configuration in FIG. 3D, the vias V0-2, V0-6 correspondingly overlap the vias VG-2, VG-3. Other configurations are within the scopes of various embodiments.

The layout 300 further comprises, in the M1 layer over the V0 layer, M1 conductive patterns separated into several masks to meet one or more design and/or manufacturing requirements. For example, the layout 300 further comprises conductive patterns M1A-1, MIA-2, M1A-3, M1A-4 corresponding to one M1 mask (referred to herein as the MIA mask), and a conductive pattern M1B-1 corresponding to another M1 mask (referred to herein as the M1B mask). The conductive patterns M1A-1, M1A-2, M1A-3, M1A-4, M1B-1 correspond to inputs B2, B1, A1, A2 and output ZN of the layout 300. Other configurations are within the scopes of various embodiments. For example, in some embodiments, a cell or circuit comprises at least one input or output in an upper metal layer other than the M1 layer, e.g., in the M2 layer, or the M3 layer, or a higher metal layer.

The conductive pattern M1A-1 is over the via V0-5. As a result, the gate region 322 is electrically coupled to the conductive pattern M1A-1, through the via VG-1, the conductive pattern M0B-3 and the via V0-5, to receive an input signal corresponding to the input B2. The conductive pattern M1A-2 is over the via V0-2. As a result, the gate region 323 is electrically coupled to the conductive pattern M1A-2, through the via VG-2, the conductive pattern M0B-2 and the via V0-2, to receive an input signal corresponding to the input B1. The conductive pattern M1A-3 is over the via V0-6. As a result, the gate region 324 is electrically coupled to the conductive pattern M1A-3, through the via VG-3, the conductive pattern M0B-4 and the via V0-4, to receive an input signal corresponding to the input A1. The conductive pattern M1A-4 is over the via V0-4. As a result, the gate region 325 is electrically coupled to the conductive pattern M1A-4, through the via VG-4, the conductive pattern M0A-4 and the via V0-4, to receive an input signal corresponding to the input A2. The conductive pattern M1B-1 is over the vias V0-1, V0-3. As a result, the MD regions 334, 338 are electrically coupled to each other and to the conductive pattern M1B-1, through the corresponding vias VD-4, VD-5, the corresponding conductive patterns M0A-2, M0A-3, and the corresponding vias V0-1, V0-3, to output an output signal corresponding to the output ZN. The conductive patterns M1A-1, M1A-2, M1A-3, M1A-4, M1B-1 provide pin-outs corresponding to the inputs B2, B1, A1, A2 and the output ZN for electrical connections of the layout 300 to the other circuitry of the IC device or to external circuitry.

In at least one embodiment, the layout 300D is one among multiple layouts generated at operation 135 in accordance with the floorplan 300B for the circuit 200, and stored in the at least one library 133 on a non-transitory computer-readable medium. In some embodiments, the layout 300D is subsequently read from the at least one library 133, and placed at operation 130 into an IC layout of an actual IC to be designed and/or manufactured.

In at least one embodiment, the layout 300D is generated, at operation 130, by reading the layout 300C from the at least one library 133, placing the layout 300C into an IC layout of an actual IC to be designed and/or manufactured, and performing routing to create the M0 conductive patterns, V0 vias, and M1 conductive patterns described with respect to FIG. 3D, to connect the nets in the layout 300C into a circuit corresponding to the circuit 200.

FIG. 3E is a schematic cross-sectional view of an IC device 300E, in accordance with some embodiments. The IC device 300E comprises a circuit region corresponding to the layout 300. A cross-section line along which the cross-sectional view of FIG. 3E is taken corresponds to the track M0_1 in FIG. 3D, and over the length of the conductive pattern M0B-3 along the X-axis. Components in FIG. 3E having corresponding components in FIGS. 3A, 3C, 3D are designated by the same reference numerals.

As shown in FIG. 3E, the IC device 300E comprises a substrate 385 over which the circuit region corresponding to the layout 300 is formed. The substrate 385 has a thickness direction along a Z-axis perpendicular to both the X-axis and Y-axis. The substrate 385 comprises, in at least one embodiment, silicon, silicon germanium (SiGe), gallium arsenic, or other suitable semiconductor or dielectric materials. In some embodiments, the substrate 385 is a P-doped substrate. In some embodiments, the substrate 385 is an N-doped substrate. In some embodiments, the substrate 385 is a rigid crystalline material other than a semiconductor material (e.g., diamond, sapphire, aluminum oxide (Al₂O₃), or the like) on which an IC is manufactured.

N-type and P-type dopants are added to the substrate 385 to form corresponding N wells in an NMOS active region corresponding to the active region OD-2, and a P well in a PMOS active region corresponding to the active region OD-1. In some embodiments, isolation structures are formed between adjacent P wells and N wells. The N well defines sources/drains 386, 387 of a transistor NB2. A gate 322 of the transistor NB2 comprises a stack of gate dielectric layers 388, 389 and a gate electrode 322. In at least one embodiment, the transistor NB2 comprises a gate dielectric layer instead of multiple gate dielectrics. Example materials of the gate dielectric layer or layers include HfO2, ZrO2, or the like. Example materials of the gate electrode 322 include polysilicon, metal, or the like.

The IC device 300E further comprises MD regions 336, 337 for electrically coupling the source/drains 386, 387 of the transistor NB2 to other circuit elements in the circuitry of the IC device 300E.

The IC device 300E further comprises an interconnect structure 390 which is over the VD and VG vias, and comprises a plurality of metal layers M0, M1, . . . and a plurality of via layers V0, V1, . . . arranged alternatingly in the thickness direction of the substrate 385, i.e., along the Z axis. The interconnect structure 390 further comprises various interlayer dielectric (ILD) layers (not shown) in which the metal layers and via layers are embedded. The metal layers and via layers of the interconnect structure 390 are configured to electrically couple various elements or circuits of the IC device 300E with each other, and with external circuitry. For simplicity, metal layers and via layers above the M1 layer are omitted in FIG. 3E. As described with respect to FIGS. 3A, 3C, 3D, a gate 322 of the transistor NB2 is coupled by a via VG-1 to an M0 conductive pattern M0B-3, which is coupled by a via V0-5 to an M1 conductive pattern M1A-1.

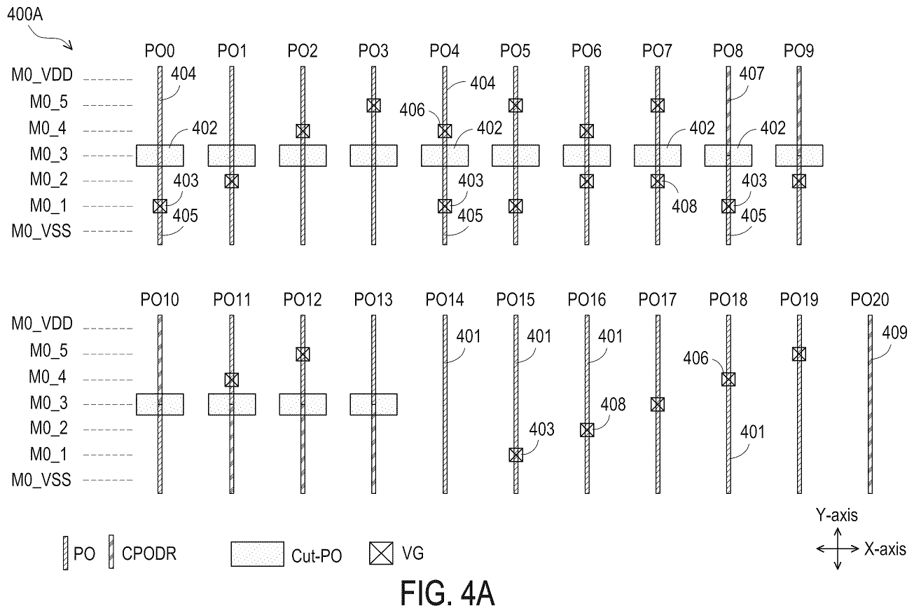

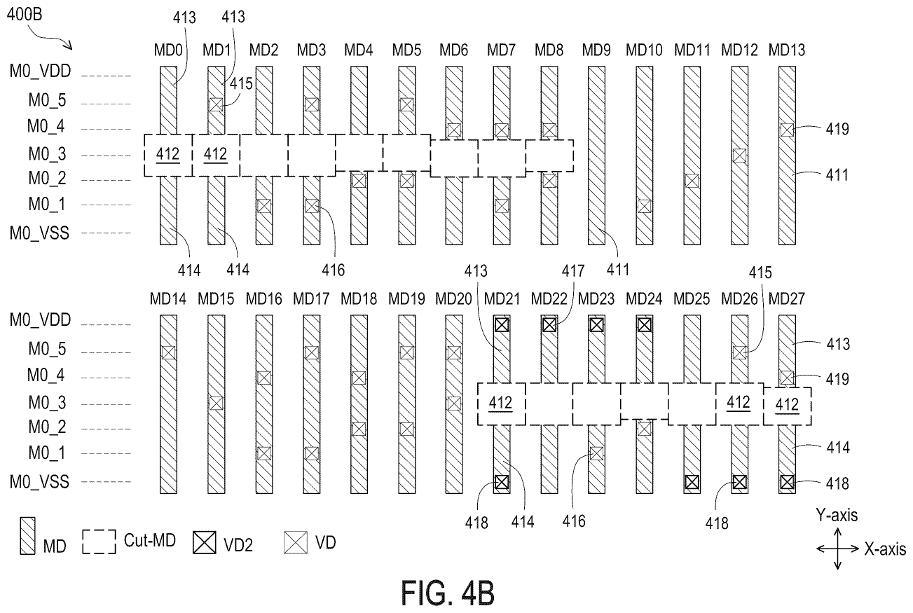

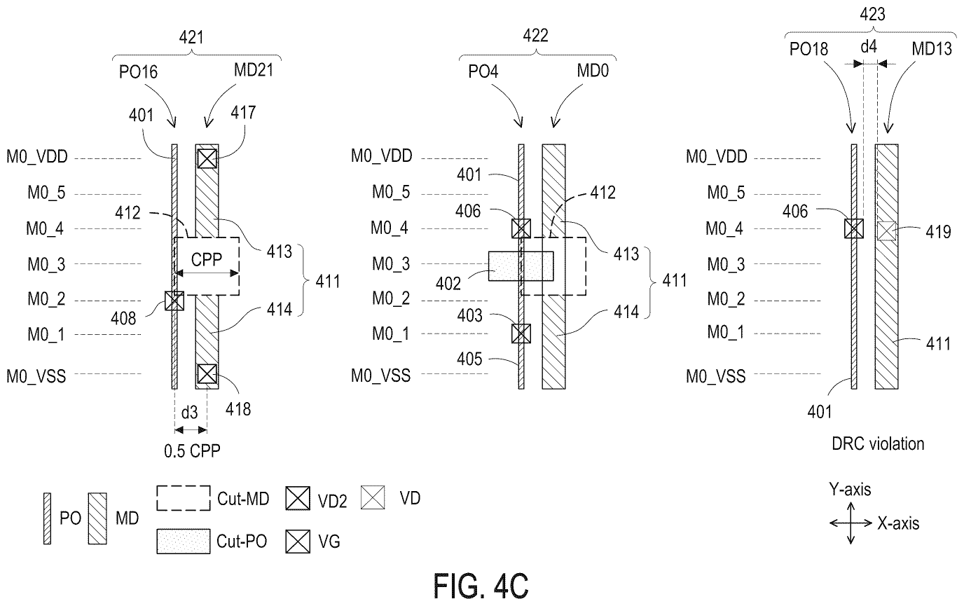

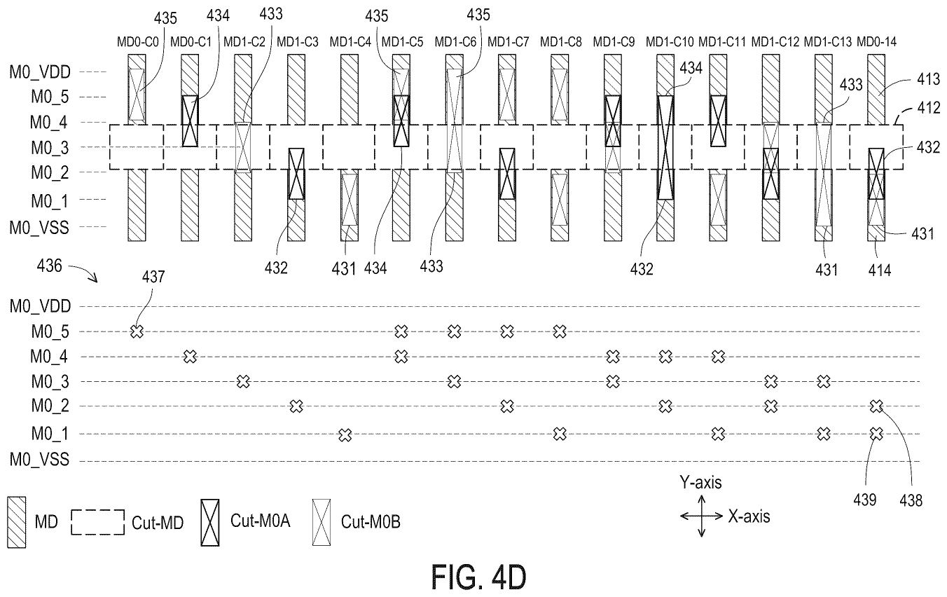

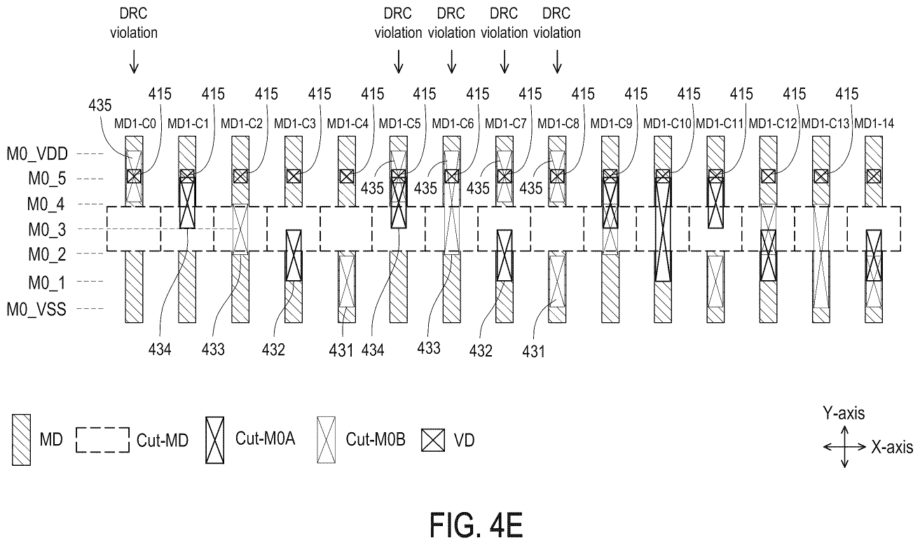

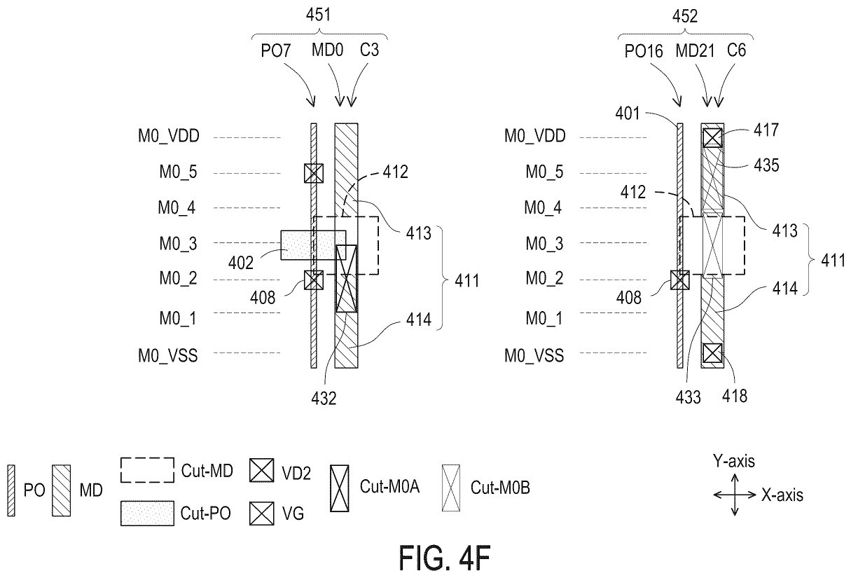

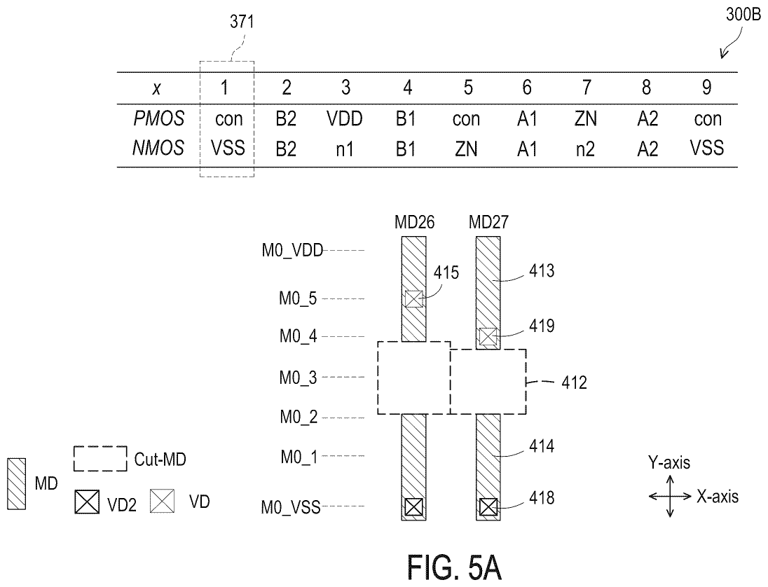

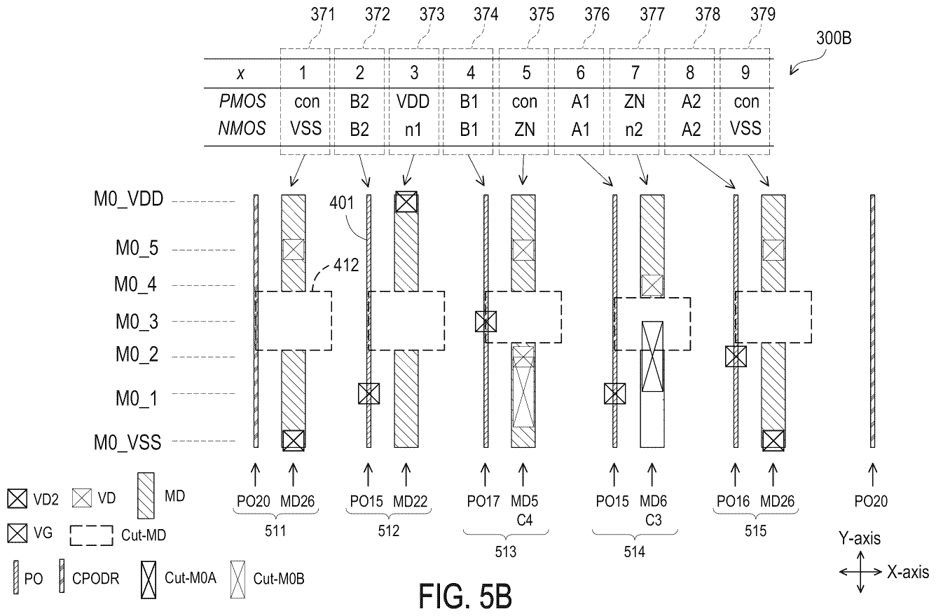

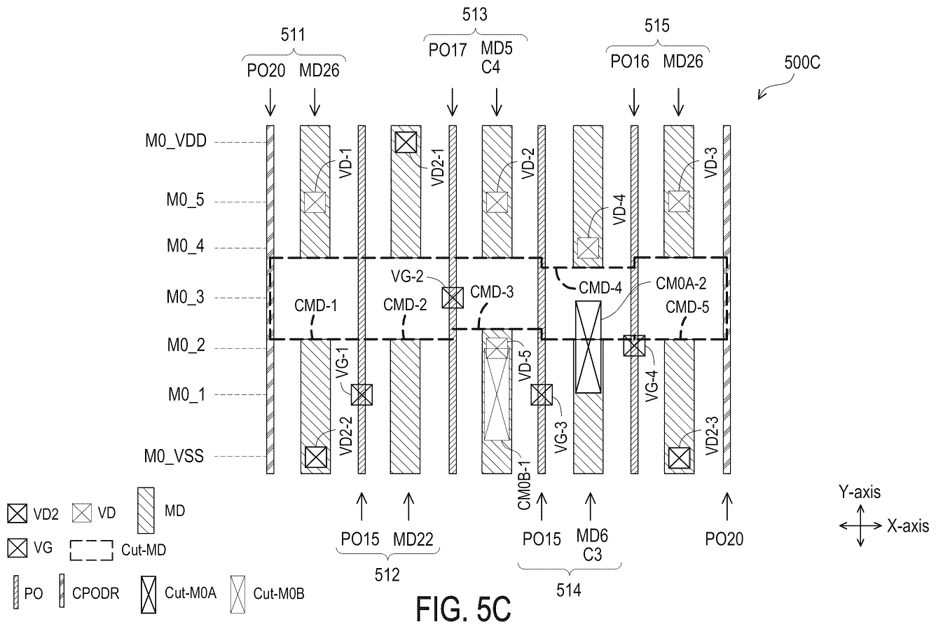

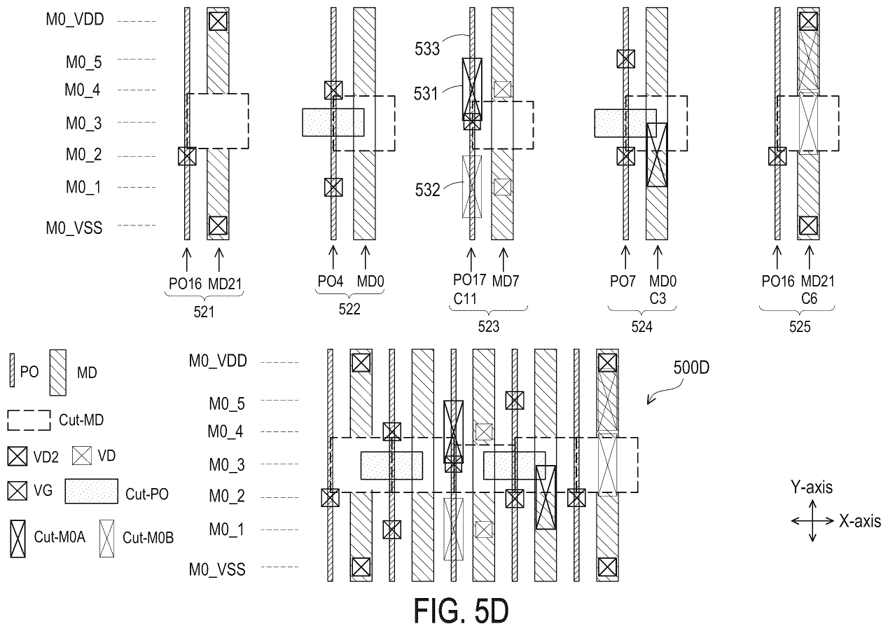

As described herein, the layout 300C is one of many layouts corresponding to the floorplan 300B. In some embodiments, multiple layouts corresponding to a floorplan of a circuit are generated and stored in at least one library. The multiple layouts provide various options of each cell for a designer to choose from, thereby permitting the designer to pick a layout best suitable for the particular IC being designed, and/or to revise the IC being designed to meet various requirements, such as PPA, timing, or the like. In some embodiments, a method to find multiple, or all possible, layouts of a circuit comprises generating layout blocks, mapping some of the generated layout blocks with a floorplan of the circuit, and combining the mapped (or selected) layout blocks into a layout of the circuit. Examples of generating layout blocks are described with respect to one or more of FIGS. 4A-4F. Examples of mapping some of the generated layout blocks with a floorplan of the circuit are described with respect to one or more of FIGS. 5A-5B. Examples of combining the mapped (or selected) layout blocks into a layout of the circuit are described with respect to one or more of FIGS. 5C-5D, 6, 7A-7D. In some embodiments, the method, including generating layout blocks, mapping some of the generated layout blocks with a floorplan of the circuit, and combining the mapped (or selected) layout blocks into a layout of the circuit, is performed, fully or at least partially, by at least one processor as described herein.

FIGS. 4A, 4B are schematic views showing various block options associated with corresponding layout features, in accordance with some embodiments. In FIG. 4A, the layout feature is a gate region, and the block options associated with the layout feature are gate block options collectively referred to as 400A. In FIG. 4B, the layout feature is a source/drain contact region (or MD region), and the block options associated with the layout feature are source/drain block options collectively referred to as 400B. Other layout features are within the scopes of various embodiments, for example, as described with respect to FIGS. 4D, 4E.

In FIG. 4A, the gate block options 400A include all possible gate block options corresponding to a given layout configuration. A layout configuration includes one or more factors that affect the numbers and/or configurations of the available block options. An example factor includes the number of M0 tracks in the cell or circuit for which multiple layouts are to be generated. A higher number of M0 tracks leads to a higher number of locations where various vias (e.g., VD and/or VG vias) are arrangeable in the layout, which, in turn, leads to a higher number of available block options and/or higher complexity of each block option. A further example factor includes the number of active regions (or cell height) in the cell or circuit for which multiple layouts are to be generated. A higher number (e.g., four) of active regions leads to a higher number of locations where various vias (e.g., VD and/or VG vias) and/or various cut regions (e.g., cut-MD regions, cut-PO regions, cut-M0 regions or the like) are arrangeable in the layout, which, in turn, leads to a higher number of available block options and/or higher complexity of each block option. Other factors in a layout configuration are within the scopes of various embodiments. Various examples discussed herein are for a layout configuration including five M0 tracks for signals, two M0 tracks for power supply, and two active regions (one PMOS active region and one NMOS active region), as described with respect to FIGS. 3A, 3C, 3D. Other layout configurations are within the scopes of various embodiments.

The gate block options (referred to herein as PO block options) in FIG. 4A include 21 PO block options PO0-PO20. Each of the PO block options 400A is a gate region (e.g., the PO block option P014), or a combination (e.g., the PO block options PO0-PO13, PO13-PO20) of a gate region with at least one of (i) at least one first cut region configured to cut or disable a portion of the gate region, or (ii) at least one first via over the gate region.

For example, the PO block option P014 is a gate region 401 that extends continuously over a PMOS active region and an NMOS active region (not shown), similarly to the gate regions 322-324 described with respect to FIG. 3A. There is no cut region or via on, or associated with, the gate region 401 in the PO block option PO14.

Each of the PO block options PO0-PO3 is a combination of a gate region, a cut-PO region, and one VG via. For example, the PO block option PO0 is a combination of the gate region 401 (not numbered), with a cut-PO region 402, and a VG via 403. The gate region 401 in the PO block option PO0 is divided by the cut-PO region 402 into gate region portions 404, 405 correspondingly over the PMOS active region and NMOS active region. The cut-PO region 402 is arranged along the track M0_3 in the middle of the cell along the Y-axis. A VG via may not overlap a cut-PO region where a gate region does not exist. Thus, a VG via is arrangeable on one of the other M0 tracks for signals, i.e., one of the tracks M0_1, M0_2, M0_4, M0_5. The PO block options PO0 includes the VG via 403 on the track M0_1. The PO block options PG1-PG3 are similar to the PO block option PO0, except for the position of the VG via which is correspondingly arranged on the tracks M0_2, M0_4, M0_5.

Each of the PO block options PG4-PO7 is a combination of a gate region, a cut-PO region, and two VG vias correspondingly on two gate region portions divided by the cut-PO region. For example, the PO block option PG4 is similar to the PO block option PO0 with the addition of a second VG via 406. The positions of the two VG vias are different among the PO block options PG4-PO7.

Each of the PO block options PG8-PO13 is a combination of a gate region, a cut-PO region dividing the gate region into two gate region portions, and a further cut region CPODR that disables one of the gate region portions. A disabled gate region portion may not have a VG via thereon. For example, the PO block option PG8 is similar to the PO block option PO0, except that the PO block option PG8 additionally includes a cut region CPODR 407 that disables the gate region portion 404. The PO block options PG9, PO11, PO12 are correspondingly similar to the PO block options PO1, PG2, PG3, except for an additional cut region CPODR that disables one of the gate region portions. While each of the PO block options PG8, PG9, PO11, PO12 includes a VG via, each of the PO block options PO10, P13 is without a VG via.

Each of the PO block options PG15-PO19 is a combination of a gate region and a VG via. The VG via is arranged correspondingly on the tracks M0_1, M0_2, M0_3, M0_4, M0_5 in the PO block options PG15-PO19. For example, PO block option PG15 includes the gate region 401, and the VG via 403 on the track M0_1, without a cut region. For another example, PO block option PO16 includes the gate region 401, and a VG via 408 on the track M0_2, without a cut region. Unlike the PO block options PO0-PO9, PO11, PO12 where no VG via is arrangeable on the track M0_3 due to the presence of a cut-PO region (e.g., the cut-PO region 402), the PO block option PO17 includes a VG via on the track M0_3 in the absence of a cut-PO region.

The PO block option P020 is a combination of a gate region, and a cut region CPODR 409 that disables the whole gate region.

All of the PO block options 400A satisfy predetermined design rules. In other words, the PO block options 400A are DRC-free.

In FIG. 4B, the source/drain block options 400B include all possible source/drain block options corresponding to a given layout configuration, i.e., the layout configuration described with respect to FIG. 4A. Other layout configurations are within the scopes of various embodiments.

The source/drain block options (referred to herein as MD block options) in FIG. 4A include 28 MD block options MD0-MD27. Each of the MD block options 400B is an MD region (e.g., the MD block option MD9), or a combination (e.g., the MD block options MD0-MD8, MD10-MD27) of an MD region with at least one of (i) at least one first cut region configured to cut or disable a portion of the MD region, or (ii) at least one first via over the MD region.

For example, the MD block option MD9 is an MD region 411 that extends continuously over a PMOS active region and an NMOS active region (not shown). There is no cut region or via on, or associated with, the MD region 411 in the MD block option MD9.

The MD block option MD0 is a combination of the MD region 411, with a cut-MD region 412, and without a via. The MD region 411 in the MD block option MD0 is divided by the cut-MD region 412 into MD region portions 413, 414 correspondingly over the PMOS active region and NMOS active region. The cut-MD region 412 is arranged along the track M0_3 in the middle of the cell along the Y-axis.

Each of the MD block options MD1, MD2, MD4, MD6 is a combination of an MD region, a cut-MD region, and one VD via. For example, the MD block option MD1 includes the MD region 411 (represented by the MD region portions 413, 414), the cut-MD region 412, and one VD via 415. A VD via may not overlap a cut-MD region where an MD region does not exist. Because the cut-MD region 412 is arranged along the track M0_3, a VD via is arrangeable on one of the other M0 tracks for signals, i.e., one of the tracks M0_1, M0_2, M0_4, M0_5. For example, in the MD block option MD1, the VD via 415 is on the track M0_5. The MD block options MD2, MD4, MD6 are similar to the MD block option MD1, except for the position of the VD via which is correspondingly arranged on the tracks M0_1, M0_2, M0_4.

Each of the MD block options MD3, MD5, MD7, MD8 is a combination of an MD region, a cut-MD region, and two VD vias correspondingly on two MD region portions divided by the cut-MD region. For example, the MD block option MD3 is similar to the MD block option MD1, with the addition of a second VD via 416. The positions of the two VD vias are different among the MD block options MD3, MD5, MD7, MD8.

Each of the MD block options MD10-MD14 is a combination of an MD region and a VD via, without a cut region. The VD via is arranged correspondingly on the tracks M0_1, M0_2, M0_3, M0_4, M0_5 in the MD block options MD10-MD14. For example, the MD block option MD13 includes the MD region 411 and a VD via 419 on the track M0_4. Unlike the MD block options MD1-MD8 where no VD via is arrangeable on the track M0_3 due to the presence of a cut-MD region (e.g., the cut-MD region 412), the MD block option MD12 includes a VD via on the track M0_3 in the absence of a cut-MD region.

Each of the MD block options MD15-MD20 is a combination of an MD region and two VD vias, without a cut region. Each of the two VD vias is arrangeable on one of the tracks M0_1, M0_2, M0_3, M0_4, M0_5. The positions of the two VD vias are different among the MD block options MD15-MD20.

The MD block option MD21 is a combination of an MD region, a cut-MD region, and two VD2 vias for power supply. For example, the MD block option MD21 is similar to the MD block option MD0, with the addition of VD2 vias 417, 418 correspondingly on the tracks M0_VDD, M0_VSS.

Each of the MD block options MD22, MD25 is a combination of an MD region, a cut-MD region, and one VD2 via for power supply. For example, the MD block option MD22 is similar to the MD block option MD21, except that the VD2 via 418 is omitted. The MD block option MD25 is similar to the MD block option MD21, except that the VD2 via 417 of the MD block option MD21 is omitted.

Each of the MD block options MD23, MD24, MD26, MD27 is a combination of an MD region, a cut-MD region, one VD via for signal, and one VD2 via for power supply. For example, the MD block option MD27 is similar to the MD block option MD21, except the VD2 via 417 of the MD block option MD21 is replaced with the VD via 419. The positions of the VD and VD2 vias are different among the MD block options MD23, MD24, MD26, MD27.

All of the MD block options 400B satisfy predetermined design rules. In other words, the MD block options 400B are DRC-free.

In some embodiments, the PO block options 400A and the MD block options 400B are stored, e.g., in the at least one library 133 on a non-transitory computer-readable medium. In at least one embodiment, a PO block option among the PO block options 400A is combined with an MD block option among the MD block options 400B in a DRC-free manner that satisfies predetermined design rules, to obtain a layout block. In at least one embodiment, all possible DRC-free combinations of a PO block option among the PO block options 400A with an MD block option among the MD block options 400B are determined, to obtain a plurality of layout blocks each including a PO block option and an MD block option. In some embodiments, because each of the PO block options 400A and each of MD block options 400B are DRC-free, and the PO block options and MD block options are combined in an DRC-free manner, the resulting plurality of layout blocks are also DRC-free. In some embodiments, the plurality of layout blocks are stored in the at least one library 133, to be later retrieved and used to build multiple layouts for various cells or circuits.

FIG. 4C includes schematic views showing example combinations 421, 422, 423 of block options associated with corresponding layout features, in accordance with some embodiments.

The combination 421 is a combination of the PO block option PO16 in FIG. 4A, and the MD block option MD21 in FIG. 4B. The PO block option PO16 is combined with the MD block option MD21 such that a distance d3 along the X-axis between the centerline of the gate region 401 in the PO block option PO16 and the centerline of the MD region 411 in the MD block option MD21 is 0.5 CPP. This distance of 0.5 CPP is the same as the center-to-center distance between a gate region and an immediately adjacent MD region in a cell layout, as described with respect to FIG. 3A. In combining the PO block option PO16 with the MD block option MD21, an edge (e.g., the left edge) of the cut-MD region 412 of the MD block option MD21 becomes coinciding with the centerline of the gate region 401 in the PO block option PO16. The PO block option PO16 is in abutment with the MD block option MD21 in the combination 421. The size (width) of the combination 421 along the X-axis is 1 CPP. The combination 421 satisfies predetermined design rules, and is accepted as a layout block to be used for building multiple layouts for various cells or circuits. Herein, a combination of a PO block option and an MD block option is referred to as a PO-MD combination, and a layout block corresponding to a PO-MD combination is referred to as a PO-MD layout block. The size (width) of a PO-MD layout block along the X-axis is 1 CPP.

The combination 422 is a PO-MD combination of the PO block option P04 in FIG. 4A, and the MD block option MD0 in FIG. 4B. The PO block option P04 is combined (or abutted) with the MD block option MD0 in a manner as described with respect to the combination 421. The combination 422 satisfies predetermined design rules, and is accepted as a PO-MD layout block to be used for building multiple layouts for various cells or circuits.

The combination 423 is a PO-MD combination of the PO block option PO18 in FIG. 4A, and the MD block option MD13 in FIG. 4B. The PO block option PO18 is combined (or abutted) with the MD block option MD13 in a manner as described with respect to the combination 421. However, the combination 423 violates a design rule with respect to an edge-to-edge distance d4 along the X-axis between the VG via 406 of the PO block option PO18 and the VD via 419 of the MD block option MD13. Both the VG via 406 and the VD via 419 are arranged on the same track M0_4, and the edge-to-edge distance d4 is smaller than a critical distance required by the design rules. The combination 423 is not accepted as a PO-MD layout block. The combination 423 is an example that not every combination (or abutment) of a PO block option and an MD block option is acceptable as a PO-MD layout block.

In some embodiments, all possible and acceptable PO-MD layout blocks, which are DRC-free, are determined from the combinations of the PO block options 400A and MD block options 400B, and are stored to be used for building multiple layouts for various cells or circuits.

The combinations 421, 422 are examples PO-MD layout blocks each obtained by combining one PO block option and one MD block option, and having a width of 1 CPP. Other combinations are within the scopes of various embodiments. For example, from the same PO block options 400A and MD block options 400B, various PO-MD-PO combinations are obtainable by arranging an MD block option between and abutting two PO block options, in a manner as described with respect to the combination 421. Each obtained PO-MD-PO combination is verified for DRC violations between the MD block option and the two PO block options, and/or between the two PO block options. If no DRC violation is found, i.e., the PO-MD-PO combination satisfies the predetermined design rules, the PO-MD-PO combination is stored as a PO-MD-PO layout block for later use. In some embodiments, all possible and acceptable PO-MD-PO layout blocks, which are DRC-free, are determined from the combinations of the PO block options 400A and MD block options 400B, and are stored to be used for building multiple layouts for various cells or circuits. A PO-MD-PO layout block has a width of 1.5 CPP along the X-axis.

In some embodiments, all possible and acceptable MD-PO-MD layout blocks, which are DRC-free, are determined from the combinations of the PO block options 400A and MD block options 400B, and are stored to be used for building multiple layouts for various cells or circuits.

In some embodiments, more complex layout blocks with greater widths are obtainable from the PO block options 400A and MD block options 400B. In at least one embodiment, all possible and acceptable PO-MD-PO-MD layout blocks, which are DRC-free, are determined from the combinations (or alternating abutment) of two PO block options among the PO block options 400A with two MD block options among the MD block options 400B. All possible and DRC-free PO-MD-PO-MD layout blocks are stored to be used for building multiple layouts for various cells or circuits. A PO-MD-PO-MD layout block has a width of 2 CPP along the X-axis.

In some embodiments, DRC-free layout blocks of a width of up to 10 CPP are obtained from the combinations (or alternating abutment) of up to ten PO block options with up to ten MD block options, and are stored to be used for building multiple layouts for various cells or circuits.

FIGS. 4D, 4E are schematic views showing various block options associated with a further layout feature, in accordance with some embodiments. The further layout feature discussed with respect to FIGS. 4D, 4E is a cut-M0 (CM0) region, and the associated block options are referred to as CM0 block options.

In FIG. 4D, the CM0 block options are not illustrated by themselves; rather, the CM0 block options are shown in combinations with the MD block option MD0. For example, in FIG. 4D, a CM0 block option C0 shown in combination with the MD block option MD0 is designated as MD0-C0, a CM0 block option C1 shown in combination with the MD block option MD0 is designated as MD0-C1, and so on, a CM0 block option C14 shown in combination with the MD block option MD0 is designated as MD0-C14.

The CM0 block options differ from each other by the number and positions of cut-M0 regions. For example, the CM0 block options C0-C4 are CM0 block options with one cut-M0 region, and correspondingly include cut-M0 regions 431-435 configured to correspondingly cut M0 conductive patterns along the tracks M0_1, M0_2, M0_3, M0_4, M0_5. The CM0 block options C5-C14 are CM0 block options with two cut-M0 regions, and correspondingly include two of cut-M0 regions 431-435 in various possible combinations. The cut-M0 regions 432, 434 belong to a cut-M0 mask CM0A configured to cut M0A conductive patterns along the tracks M0_2, M0_4. The cut-M0 regions 431, 433, 435 belong to a cut-M0 mask CM0B configured to cut M0B conductive patterns along the tracks M0_1, M0_3, M0_5.

In FIG. 4D, a diagram 436 shows, at each of a plurality of “X” marks, the M0 track being cut by a cut-M0 region in a corresponding CM0 block option. In an example, the “X” mark 437 shows that the cut-M0 region 435 in the CM0 block option C0 is configured to cut a M0 conductive pattern along the track M0_5. In another example, the “X” marks 438, 439 show that the cut-M0 regions 432, 431 in the CM0 block option C14 are correspondingly configured to cut M0 conductive patterns along the tracks M0_1, M0_2.

The schematic diagram in FIG. 4D does not show all possible CM0 block options. For example, CM0 block options each including three, four or five cut-M0 regions are not illustrated, for simplicity. However, all CM0 block options each including one, two, three, four or five cut-M0 regions are considered for combination with the PO block options 400A and/or the MD block options 400B to form layout blocks for building multiple layouts for various cells or circuits. As illustrated in FIG. 4D, in a combination with an MD block option, the cut-M0 region(s) of a CM0 block option are arranged over the MD region of the MD block option. In a combination with a PO block option, the cut-M0 region(s) of a CM0 block option are arranged over the gate region of the PO block option. An example of a combination of a CM0 block option with a PO block option is included in a layout block 523 in FIG. 5D.

If a combination of an MD block option and a CM0 block option is DRC-free, it is referred to as an MD-MC0 block option. For example, in FIG. 4D, all combinations of the CM0 block options C0-C14 with the MD block option MD0 satisfy predetermined design rules, and are DRC-free. Thus, all combinations of the CM0 block options C0-C14 with the MD block option MD0 in FIG. 4D are MD-MC0 block options. If a combination of a PO block option and a CM0 block option is DRC-free, it is referred to as a PO-MC0 block option. An MD-MC0 block option or an MD block option is considered for further combination with a PO block option or a PO-MC0 block option. If the combination is DRC-free, it is considered as a layout block to be used for building multiple layouts for various cells or circuits. In some embodiments, an MD-MC0 block option is considered as an MD block option which includes one or more cut-M0 region(s), in addition to an MD region, any cut-MD region and/or any VD via. In some embodiments, a PO-MC0 block option is considered as a PO block option which includes one or more cut-M0 region(s), in addition to a gate region, any cut-PO region and/or any VG via and/or any cut region CPODR.

In FIG. 4E, the CM0 block options are shown in combination with the MD block option MD1. For example, in FIG. 4E, the CM0 block option C0 shown in combination with the MD block option MD1 is designated as MD1-C0, the CM0 block option C1 shown in combination with the MD block option MD1 is designated as MD1-C1, and so on, the CM0 block option C14 shown in combination with the MD block option MD1 is designated as MD1-C14. Similarly to FIG. 4D, the schematic diagram in FIG. 4E does not show all possible CM0 block options, e.g., CM0 block options each including three, four or five cut-M0 regions are not illustrated, for simplicity.

The schematic diagram in FIG. 4E shows that not every combination of a CM0 block option and an MD block option is DRC-free or acceptable for further combination with a PO block option. For example, in the combination MD1-C0, the VD via 415 of the MD block option MD1 overlaps the cut-M0 region 435 of the CM0 block option C0. The cut-M0 region 435 removes the M0 conductive pattern over the VD via 415, and leaves no M0 conductive pattern to be electrically coupled with the VD via 415. This is a DRC violation, and the combination MD1-C0 is not considered as an MD-MC0 block option and is excluded from further combination with a PO block option. A similar situation with the VD via 415 overlapping the cut-M0 region 435 is observed in the combinations MD1-C5, MD1-C6, MD1-C7, MD1-C8 all of which are not considered as MD-MC0 block options and are excluded from further combination with a PO block option.

Although in the combination MD1-C1, the VD via 415 partially overlaps the cut-M0 region 434, this is not a DRC violation. A reason is that the cut-M0 region 434 is configured to cut M0 conductive patterns along the track M0_4, and does not effect M0 conductive patterns along the track M0_5 on which the VD via 415 is arranged. Except for the combinations MD1-C0, MD1-C5, MD1-C6, MD1-C7, MD1-C8, all other combinations of the CM0 block options with the MD block option MD1 in FIG. 4E satisfy predetermined design rules, are DRC-free, and are MD-MC0 block options to be considered for further combination with a PO block option.

The described combinations of some CM0 block options with the MD block option MD0 in FIG. 4D, and with the MD block option MD1 in FIG. 4E are examples. In some embodiments, combinations of all CM0 block options, including CM0 block options with more than two cut-M0 regions, with all MD block options MD0-MD27 and with all PO block options PO0-PO20 are determined. All MD-MC0 and PO-MC0 combinations that are DRC-free are considered as MD-MC0 and PO-MC0 block options. All MD-MC0 block options and all MD block options MD0-MD27 are considered as MD block options. All PO-MC0 block option and all PO block options PO0-PO20 are considered as PO block options. All possible combinations of all MD block options and all PO block options, with up to 10 CPP in width, are determined. All combinations that are DRC-free are stored as layout blocks to be used for building multiple layouts for various cells or circuits.

FIG. 4F includes schematic views showing example combinations 451, 452 of block options associated with corresponding layout features, in accordance with some embodiments.

The combination 451 is a PO-MD-CM0 combination of the PO block option P07 in FIG. 4A, the MD block option MD0 in FIG. 4B, and the CM0 block option C3 described with respect to FIG. 4D. The cut-M0 region 432 of the CM0 block option C3 is arranged over the MD region 411 of the MD block option MD0, resulting in the MD-MC0 block option MD0-C3 as shown in FIG. 4D. The MD-MC0 block option MD0-C3 is combined (i.e., abutted) with the PO block option P07 in a manner similar to that described with respect to FIG. 4C, to obtain the combination 451. The combination 451 satisfies predetermined design rules, and is accepted as a layout block, with a width of 1 CPP, to be used for building multiple layouts for various cells or circuits.

The combination 452 is a PO-MD-CM0 combination of the PO block option PO16 in FIG. 4A, and the MD block option MD21 in FIG. 4B, and the CM0 block option C6 described with respect to FIG. 4D. The cut-M0 regions 433, 435 of the CM0 block option C6 are arranged over the MD region 411 of the MD block option MD21, resulting in a MD-MC0 block option. The MD-MC0 block option is combined (i.e., abutted) with the PO block option PO16 in a manner similar to that described with respect to FIG. 4C, to obtain the combination 452. The combination 452 satisfies predetermined design rules, and is accepted as a layout block, with a width of 1 CPP, to be used for building multiple layouts for various cells or circuits.

FIG. 5A is a schematic view showing an example of mapping block options associated with a layout feature to a floorplan of a circuit of an IC device, in accordance with some embodiments. In the example in FIG. 5A, the MD block options 400B are mapped to the source/drain block 371 in the floorplan 300B to determine which of the MD block options 400B matches the one or more nets in the source/drain block 371. In some embodiments, the mapping is performed in accordance with one or more LVS rules, as follows.

In response to the source/drain block 371 including two different nets con and VSS, it is determined, e.g., by at least one processor, that a matching MD block option must include a cut-MD region to electrically separate the two nets. As a result, the MD block options MD9-MD20 which include no cut-MD region are excluded.

In response to the source/drain block 371 including the net VSS corresponding to the NMOS active region, it is determined, e.g., by at least one processor, that a matching MD block option must include a VD2 via corresponding to the NMOS active region. As a result, all MD block options other than the MD block options MD21, MD25, MD26, MD27 are excluded.

In response to the source/drain block 371 including the net con corresponding to the PMOS active region, it is determined, e.g., by at least one processor, that a matching MD block option must include a VD via corresponding to the PMOS active region for connection for the net con. Among the remaining MD block options MD21, MD25, MD26, MD27, only the MD block options MD26, MD27 meet this requirement.

Thus, based on the nets con and VSS associated with the source/drain block 371, it is determined, e.g., by at least one processor, that a matching layout block must include one of the MD block options MD26, MD27. In some embodiments, all layout blocks that include the MD block option MD26 or MD27 are selected to be used for building a layout in accordance with the floorplan 300B.

In some embodiments, the described mapping is performed to map, not only the MD block options 400B in FIG. 4B, but also the available MD-MC0 block options with one or more cut-M0 regions to the source/drain block 371. The described mapping is performed for all other source/drain blocks 373, 375, 377, 379 in the floorplan 300B.

In some embodiments, a similar mapping is performed to map, e.g., by at least one processor, one or more of the available PO block options to each of the gate blocks 372, 374, 376, 378 of the floorplan 300B. An example result of the described gate block mapping and source/drain block mapping is given in FIG. 5B.

FIG. 5B is a schematic view showing an example result of mapping various layout blocks to the floorplan 300B, in accordance with some embodiments.

As discussed with respect to FIG. 5A, all layout blocks that include the MD block option MD26 or MD27 are selected as layout blocks matching the source/drain block 371 of the floorplan 300B. One of those selected layout blocks is a layout block 511 which includes the MD block option MD26. The layout block 511 further comprises the PO block option P20 corresponding to a cell boundary on the left side of the source/drain block 371.

As a result of a mapping of the available PO block options to the gate block 372 based on the nets B2, B2 associated with the gate block 372, it is determined that a matching layout block must include one of the PO block options PO15-PO19. As a result of a mapping of the available MD block options to the source/drain block 373 based on the nets VDD, n1 associated with the source/drain block 373, it is determined that a matching layout block must include the MD block option MD22 which is the only MD block option that matches the net VDD (VD2 on the PMOS) and net n1 (no VD on the NMOS). All layout blocks that include one of the PO block options PO15-PO19 and the MD block option MD22 are selected as layout blocks matching both the gate block 372 and the source/drain block 373 of the floorplan 300B. One of those selected layout blocks is a layout block 512 which includes the PO block option PO15 and MD block option MD22.

Similar block option mappings and layout block selections are performed for the remaining blocks 374-379 of the floorplan 300B. In the example result in FIG. 5B, a layout block 513 includes the PO block option PO17 that matches the gate block 374, and a combination of the MD block option MD5 with the CM0 block option C4 that matches the source/drain block 375. A layout block 514 includes the PO block option PO15 that matches the gate block 376, and a combination of the MD block option MD6 with the CM0 block option C3 that matches the source/drain block 377. A layout block 515 includes the PO block option PO16 that matches the gate block 378, and the MD block option MD26 that matches the source/drain block 379. The PO block option P20 corresponding to a cell boundary on the right side of the layout block 515 is added.

In some embodiments, the selected layout blocks 511-515 are combined by abutment, in a manner similar to that described with respect to FIG. 4C. For example, to abut the layout block 511 with the layout block 512, the right edge of the cut-MD region 412 of the MD block option MD26 in the layout block 511 is aligned with the centerline of the gate region 401 of the PO block option PO15 in the layout block 512. The other selected layout blocks 513-515 are further abutted to each other and to the right side of the layout block 512 in similar manners.

FIG. 5C is a schematic view of a layout 500C obtained by combining the various layout blocks 511-515 in FIG. 5B, in accordance with some embodiments. In this example, the layout 500C corresponds to the layout 300C described with respect to FIG. 3C.

The layout 500C is just a layout solution among many other layout solutions that are generated in accordance with the floorplan 300B. An alternative layout solution (not shown) includes the MD block option MD26 for the source/drain block 371, the PO block option PO17 for the gate block 372, the MD block option MD22 for the source/drain block 373, the PO block option PO18 for the gate block 374, a combination of the MD block option MD3 and the CM0 block option C9 for the source/drain block 375, the PO block option PO16 for the gate block 376, the MD block option MD6 for the source/drain block 377, the PO block option PO17 for the gate block 378, and the MD block option MD26 for the source/drain block 379.

In some embodiments, as described herein, all possible layout solutions corresponding to a floorplan, such as the floorplan 300B, of a circuit are generated from predetermined layout blocks. As a result, it is possible for an IC designer to find a better layout for the same circuit than the current layout, making it possible to improve IC layouts in one or more embodiments.

In some embodiments, the same predetermined layout blocks are usable to generate layout solutions for different circuits, for example, as described with respect to FIG. 5D.

FIG. 5D includes a schematic view showing an example of mapping various layout blocks to a floorplan of a circuit of an IC device, and a schematic view of a layout 500D obtained by combining the various layout blocks, in accordance with some embodiments. The circuit in FIG. 5D is XOR2D1, i.e., different from the AOI22D1 circuit discussed with respect to FIG. 5C. XOR2D1 is a 2-input XOR gate with the driving strength of 1. A floorplan of XOR2D1 is different from the floorplan 300B, and is not shown in FIG. 5D.

In FIG. 5D, as a result of mapping the available PO, MD and/or CM0 block options to various source/drain blocks and gate blocks in a floorplan of XOR2D1, as described with respect to FIGS. 5A-5B, various matching PO, MD and/or CM0 block options are identified, and one or more of the available layout blocks are selected based on the matching PO, MD and/or CM0 block options. The selected layout blocks together include a set of alternating gate block options and source/drain block options correspondingly mapped to the plurality of alternating gate blocks and source/drain blocks in the floorplan. For example, a set of selected layout blocks in FIG. 5D includes layout blocks 521-525 which include various PO, MD and/or CM0 block options which are usable to generate various layout solutions for another circuit, e.g., AOI22D1, as described with respect to FIG. 5C.

The layout block 521 includes the PO block option PO16 for a gate block, and the MD block option MD21 for a source/drain block in the floorplan of XOR2D1. The layout block 522 includes the PO block option P04 for a gate block, and the MD block option MD0 for a source/drain block in the floorplan of XOR2D1. The layout block 523 includes a combination of the PO block option PO17 with the CM0 block option C11 for a gate block, and the MD block option MD7 for a source/drain block in the floorplan of XOR2D1. In the combination of the PO block option PO17 with the CM0 block option C11, cut-M0 regions 531, 532 of the CM0 block option C11 are arranged over a gate region 533 of the PO block option PO17. The layout block 524 includes the PO block option P07 for a gate block, and a combination of the MD block option MD0 with the CM0 block option C3 for a source/drain block in the floorplan of XOR2D1. The layout block 525 includes the PO block option PO16 for a gate block, and a combination of the MD block option MD21 with the CM0 block option C6 for a source/drain block in the floorplan of XOR2D1. The layout 500D is obtained by combining, e.g., abutting, the various layout blocks 521-525. The layout 500D is just a layout solution among many other layout solutions that are generated in accordance with the floorplan of XOR2D1.

In the described examples, PO-MD and/or PO-MD-CM0 layout blocks with a width of 1 CPP are used to generate layout solutions. Other, larger layout blocks with a width of up to 10 CPP are usable in similar manners to generate layout solutions.

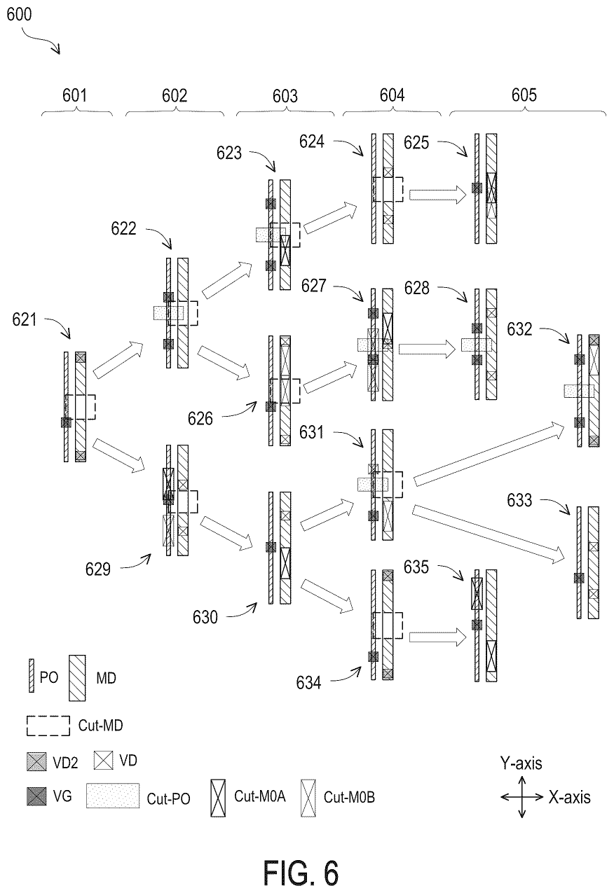

FIG. 6 is a schematic view showing a search 600 for combining various layout blocks mapped to a floorplan of a circuit of an IC device into various layout diagrams of the circuit, in accordance with some embodiments. In the example in FIG. 6, the search 600 comprises a depth-first search (DFS) algorithm executed by at least one processor. In at least one embodiment, the DFS algorithm starts at the root of a search tree and explores as far (or deep) as possible or necessary along each branch before backtracking.

For example, the floorplan of the circuit comprises blocks 601-605 each of which comprises a gate block and a source/drain block. The search 600 starts from a layout block 621 matching the block 601 of the floorplan. The search 600 then looks for and finds a first layout block 622 matching the block 602 of the floorplan. The search 600 then looks for and finds a first layout block 623 matching the block 603 of the floorplan. The search 600 then looks for and finds a first layout block 624 matching the block 604 of the floorplan. The search 600 then looks for and finds a first layout block 625 matching the block 605 of the floorplan. At this point a first layout solution including the layout blocks 621-625 matching the floorplan is obtained and stored. The search 600 then looks for another layout block matching the block 605 to be combined with the current layout block 624 corresponding to the block 604.

When a next layout block matching the block 605 is not found or, due to one or more design rules, is not combinable with the current layout block 624 corresponding to the block 604, the search 600 backtracks one level to look for a next layout block matching the block 604.

When a next layout block matching the block 604 is not found or, due to one or more design rules, is not combinable with the current layout block 623 corresponding to the block 603, the search 600 backtracks one further level to look for a next layout block matching the block 603.

When a layout block 626 matching the block 603 is found, the search 600 then looks for a first layout block matching the block 604 of the floorplan and combinable with the layout block 626. When a layout block 627 is found, the search 600 then looks for a first layout block matching the block 605 of the floorplan and combinable with the layout block 627. When a layout block 628 is found, a second layout solution including the layout blocks 621, 622, 626, 627, 628 matching the floorplan is obtained and stored.

The search 600 progresses in similar manners to find third to fifth layout solutions. The third layout solution includes layout blocks 621, 629, 630, 631, 632. The fourth layout solution includes layout blocks 621, 629, 630, 631, 633. The fifth layout solution includes layout blocks 621, 629, 630, 634, 635.

At this point, it is determined that the search for layout solutions starting with the layout block 621 has been exhaustive, and the search 600 switches to a new search tree starting from a further layout block matching the block 601 of the floorplan. The described algorithm is then repeated in a similar manner to perform an exhaustive search for all possible layout solutions matching the floorplan.

While other search methodologies, e.g., breadth-first search, are usable in accordance with some embodiments to find all possible layout solutions corresponding to a floorplan, the described DSF is advantageous in quickly locating first layout solutions.

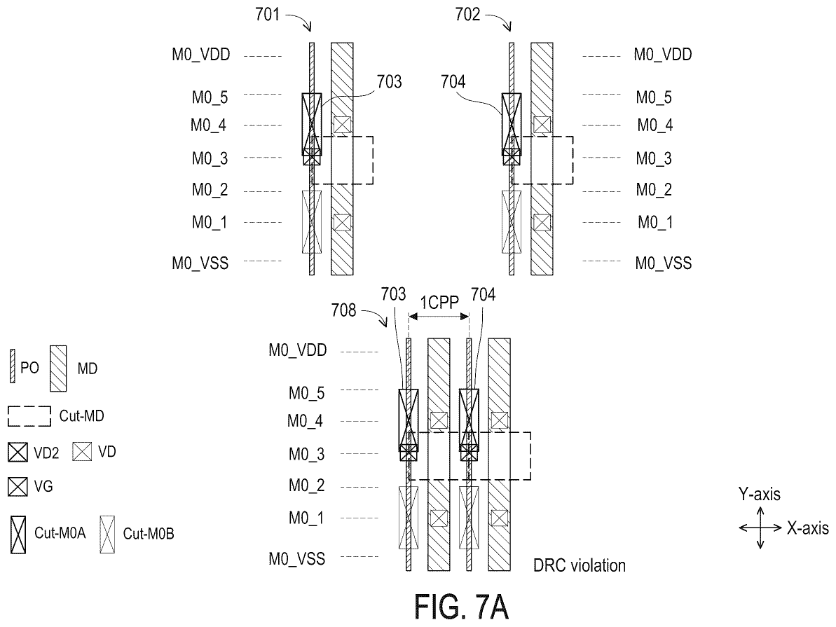

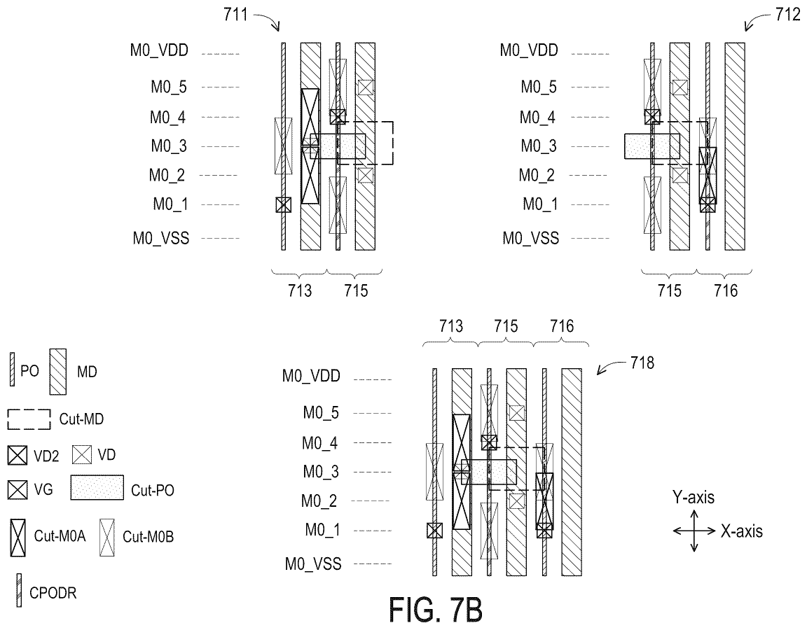

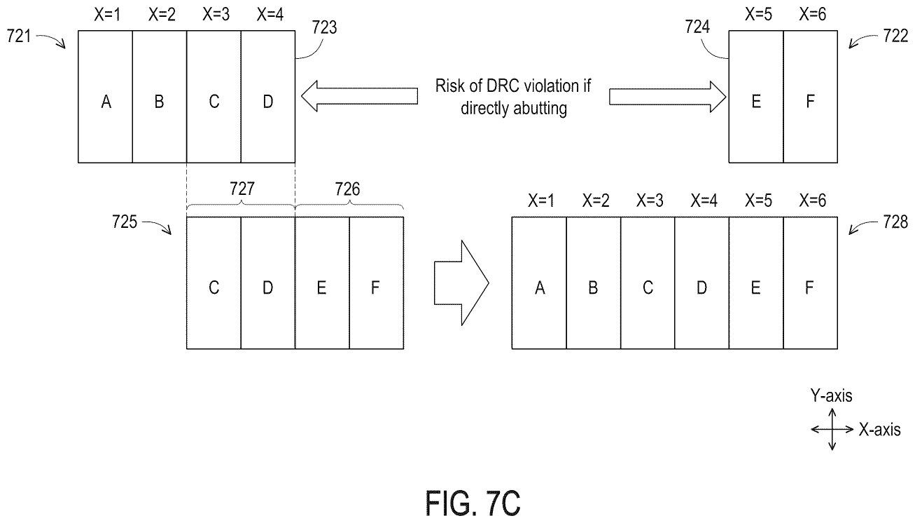

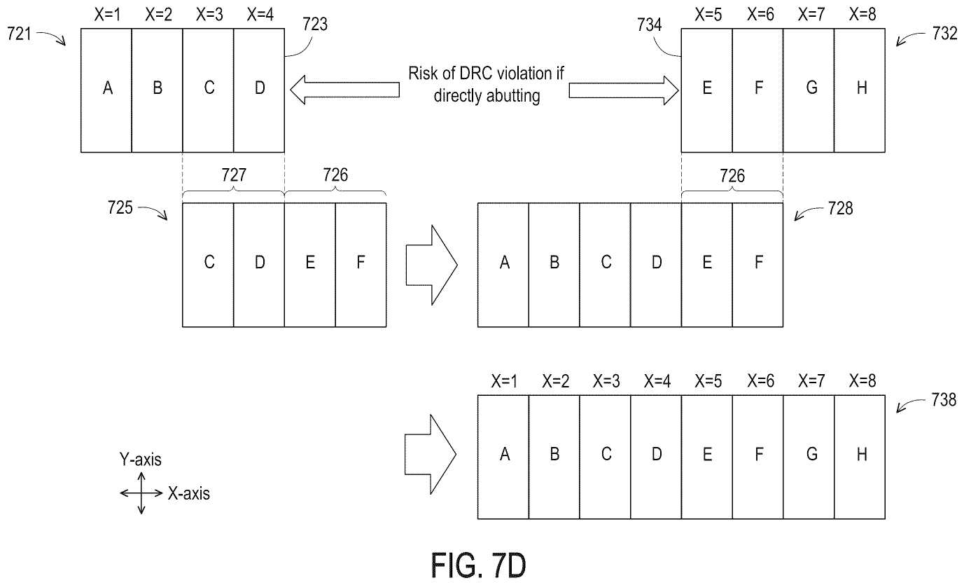

In some embodiments as described herein, one or more layout blocks are combined with each other by abutting one layout block with another, in a manner similar to that described with respect to FIG. 4C. Other ways for combining layout blocks are within the scopes of various embodiments, for example, as described with respect to FIGS. 7B-7D.

FIG. 7A is a schematic view showing a potential design rule violation when certain layout blocks are combined.

In the simplified example in FIG. 7A, two identical layout blocks 701 and 702 are to be combined. The layout blocks 701 and 702 also the same as the layout block 523 described with respect to FIG. 5D. The layout blocks 701 and 702 are combined, resulting in a combined layout block 708 in which a center-to-center distance along the X-axis between a cut-M0 region 703 of the layout block 701 and a cut-M0 region 704 of the layout block 702 is 1 CPP. A predetermined design rule requires that cut-M0 regions on the same M0 track should be spaced by a center-to-center distance being greater than 1 CPP. Therefore, the combination of the layout blocks 701 and 702 results in a DRC violation.

The example situation described with respect to FIG. 7A illustrates a potential risk of DRC violation when layout blocks are combined. It is possible to make certain checks after layout blocks are combined to determine whether there is a DRC violation in the combined layout block. Such checks, however, may slow down the search for multiple layout solutions corresponding to a floorplan. In at least one embodiment, a potential risk of DRC violation is reduced when layout blocks are combined not by abutting, but by overlapping in an identical border region, as described with respect to FIGS. 7B-7D.

FIG. 7B is a schematic views showing an example of combining layout blocks, in accordance with some embodiments.

In FIG. 7B, layout blocks 711, 712 are to be combined. Each of the layout blocks 711, 712 is a PO-MD-PO-MD layout block having a width of 2 CPP. The layout block 711 includes a first region 713, and a border region 715. The layout block 712 includes a second region 716, and a border region 715. The border region 715 of the layout block 711 is identical to the border region 715 of the layout block 712. As described herein, layout blocks are generated in such a manner to ensure that predetermined design rules are satisfied, i.e., the layout blocks are DRC-free. As also described herein, to ensure that layout blocks are DRC-free, various block options used to generate layout blocks are DRC-free, and are combined with each other in a DRC-free manner. Combinations of block options are excluded from being used as layout blocks when it is determined that such combinations are not DRC-free, for example, as described with respect to FIGS. 4C, 4E. Because the layout blocks 711, 712 are DRC-free, there is no risk of DRC violation between the first region 713 and the border region 715 in the layout block 711, and between the second region 716 and the border region 715 in the layout block 712.

In some embodiments, the layout blocks 711, 712 are combined by overlapping the layout blocks 711, 712 in their identical border region 715, i.e., by overlapping the border region 715 of the layout block 711 over the identical border region 715 of the layout block 712. A resulting combined layout block 718 comprises the first region 713, the second region 716, and the border region 715 (which is no longer a border region) between the first region 713 and the second region 716.

Because there is no risk of DRC violation between the first region 713 and the border region 715 in the layout block 711, there is also no risk of DRC violation between the first region 713 and the border region 715 in the combined layout block 718. Because there is no risk of DRC violation between the second region 716 and the border region 715 in the layout block 712, there is also no risk of DRC violation between the second region 716 and the border region 715 in the combined layout block 718. As a result the combined layout block 718 is DRC-free, or at least DRC-less, in one or more embodiments. Various approaches for utilizing the described combination technique by overlapping identical border regions are described with respect to FIGS. 7C-7D.

FIG. 7C is a schematic views showing an example of combining layout blocks, in accordance with some embodiments.

In FIG. 7C, layout blocks 721, 722 are to be combined. For example, the layout block 721 includes block options A, B, C, D corresponding to blocks X=1, X=2, X=3, X=4 in a floorplan. In some situations, the layout block 721 is a predetermined layout block that is DRC-free. In other situations, the layout block 721 is a DRC-free combination of two DRC-free layout blocks, one including the blocks A, B, whereas the other including the block options C, D. The layout block 722 includes block options E, F corresponding to blocks X=5, X=6 in the floorplan. The layout block 721 is to be combined with the layout block 722 such that the block options A, B, C, D become contiguous to the block options E, F in accordance with the corresponding blocks X=1, X=2, X=3, X=4, X=5, X=6 in the floorplan. In some embodiments, the block options A, C, E include PO or MD block options, and the block options B, D, F include MD or PO block options.

An approach for combining the layout blocks 721, 722, in accordance with some embodiments, involves abutting the layout block 721 and the layout block 722 along the corresponding facing edges 723, 724. There might be, however, a risk of DRC violation in this approach in certain situations, as discussed with respect to FIG. 7A.

An alternative approach, in accordance with some embodiments, involves overlapping, rather than abutting layout blocks, as discussed with respect to FIG. 7B. In this approach, an intermediate layout block 725 including block options C, D, E, F is sought among the predetermined layout blocks and/or previously combined, DRC-free layout blocks. The intermediate layout block 725 includes a first region 726, and a border region 727. The border region 727 includes the block options C, D and is identical to a corresponding border region including the block options C, D in the layout block 721. The first region 726 of the intermediate layout block 725 includes the block options E, F of the layout block 722. When the intermediate layout block 725 is found, the layout block 721 and the intermediate layout block 725 are overlapped in their identical border region 727, resulting in a combined layout block 728 which includes the block options A, B, C, D, E, F corresponding to the blocks X=1, X=2, X=3, X=4, X=5, X=6 in the floorplan.

Because each of the layout block 721 and the intermediate layout block 725 is predetermined or combined to be DRC-free, there is no risk of DRC violation among block options A, B, C, D of the layout block 721, and there is no risk of DRC violation among block options C, D, E, F of the intermediate layout block 725. As a result, there is no risk of DRC violation among the block options A, B, C, D, E, F in the combined layout block 728 which is equivalent to a combination of the layout blocks 721, 722 being abutted along their facing edges 723, 724.

In some embodiments, instead of abutting the layout blocks 721, 722 along their facing edges 723, 724 and then performing one or more checks for DRC violation, at least one processor is configured to search for an existing, DRC-free intermediate layout block 725 which is then combined with the layout block 721 by overlapping the layout blocks 721, 725 in an identical border region 727 thereof. In at least one embodiment, the obtained combined layout block 728 is DRC-free or at least DRC-less. As a result, it is possible to quickly combine layout blocks in accordance with the floorplan, while ensuring that obtained layout solutions are DRC-free or at least DRC-less.

FIG. 7D is a schematic views showing an example of combining layout blocks, in accordance with some embodiments.

In FIG. 7D, layout blocks 721, 732 are to be combined. The layout block 721 is described with respect to FIG. 7C. The layout block 732 includes block options E, F, G, H corresponding to blocks X=5, X=6, X=7, X=8 in a floorplan. In some situations, the layout block 732 is a predetermined layout block that is DRC-free. In other situations, the layout block 732 is a DRC-free combination of two DRC-free layout blocks, one including the blocks E, F, whereas the other including the block options G, H. The layout block 721 is to be combined with the layout block 732 such that the block options A, B, C, D become contiguous to the block options E, F, G, H in accordance with the corresponding blocks X=1, X=2, X=3, X=4, X=5, X=6, X=7, X=8 in the floorplan. In some embodiments, the block options A, C, E, G include PO or MD block options, and the block options B, D, F, H include MD or PO block options.

An approach for combining the layout blocks 721, 732, in accordance with some embodiments, involves abutting the layout block 721 and the layout block 732 along the corresponding facing edges 723, 734. There might be, however, a risk of DRC violation in this approach in certain situations, as discussed with respect to FIG. 7A.

An alternative approach, in accordance with some embodiments, involves overlapping, rather than abutting layout blocks, as discussed with respect to FIGS. 7B, 7C. In this approach, an intermediate layout block 725 including block options C, D, E, F is sought among the predetermined layout blocks and/or previously combined, DRC-free layout blocks. The intermediate layout block 725 includes a first border region 726, and a second border region 727. The second border region 727 includes the block options C, D and is identical to a corresponding border region including the block options C, D in the layout block 721. The first border region 726 of the intermediate layout block 725 includes the block options E, F and is identical to a corresponding border region including the block options E, F in the layout block 732.

When the intermediate layout block 725 is found, the layout block 721 and the intermediate layout block 725 are overlapped in their identical border region 727, resulting in an intermediate combined layout block 728 which includes the block options A, B, C, D, E, F corresponding to the blocks X=1, X=2, X=3, X=4, X=5, X=6 in the floorplan.

The intermediate combined layout block 728 has the border region 726 identical to the corresponding border region including the block options E, F in the layout block 732. The layout block 732 and the intermediate combined layout block 725 are overlapped in their identical border region 726, resulting in a combined layout block 738 which includes the block options A, B, C, D, E, F, G, H corresponding to the blocks X=1, X=2, X=3, X=4, X=5, X=6, X=7, X=8 in the floorplan.

Because each of the layout block 721, the intermediate layout block 725 and the layout block 732 is predetermined or combined to be DRC-free, there is no risk of DRC violation among block options A, B, C, D of the layout block 721, there is no risk of DRC violation among block options C, D, E, F of the intermediate layout block 725, and there is no risk of DRC violation among block options E, F, G, H of the layout block 732. As a result, there is no risk of DRC violation among the block options A, B, C, D, E, F, G, H in the combined layout block 738 which is equivalent to a combination of the layout blocks 721, 732 being abutted along their facing edges 723, 734.

In some embodiments, instead of abutting the layout blocks 721, 732 along their facing edges 723, 734 and then performing one or more checks for DRC violation, at least one processor is configured to search for an existing, DRC-free intermediate layout block 725 which includes two border regions correspondingly identical to border regions in the layout blocks 721, 732 to be combined. The intermediate layout block 725 is then combined with the layout blocks 721, 732 by overlapping in the identical border regions. In at least one embodiment, the obtained combined layout block 738 is DRC-free or at least DRC-less. As a result, it is possible to quickly combine layout blocks in accordance with the floorplan, while ensuring that obtained layout solutions are DRC-free or at least DRC-less. In the examples described with respect to FIGS. 7B-7D, the border region where one layout block overlaps another layout block, includes a PO block option and an MD block option, and has a width of 1 CPP. Larger border regions (or overlap regions) are within the scopes of various embodiments. In some embodiments, an overlap region has a width of up to 5 CPP. In some embodiments, one or more of the described methods, processes or search methodologies are applicable to find all possible routings in multiple metal layers, e.g., in one or more of the M0, M1, M2, M3 layers.

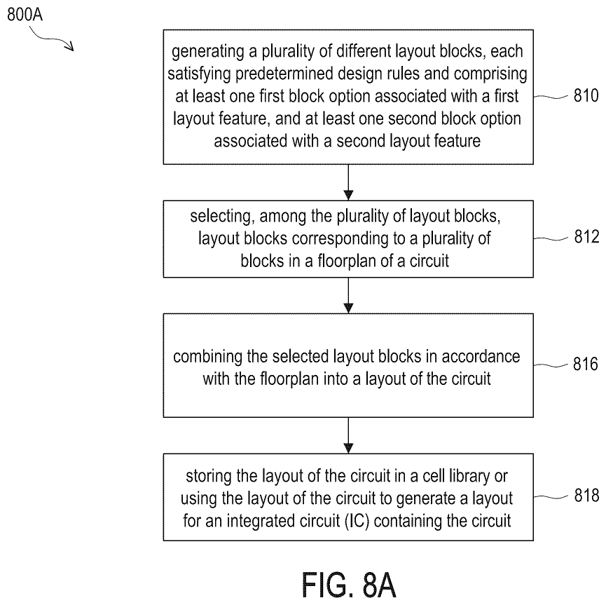

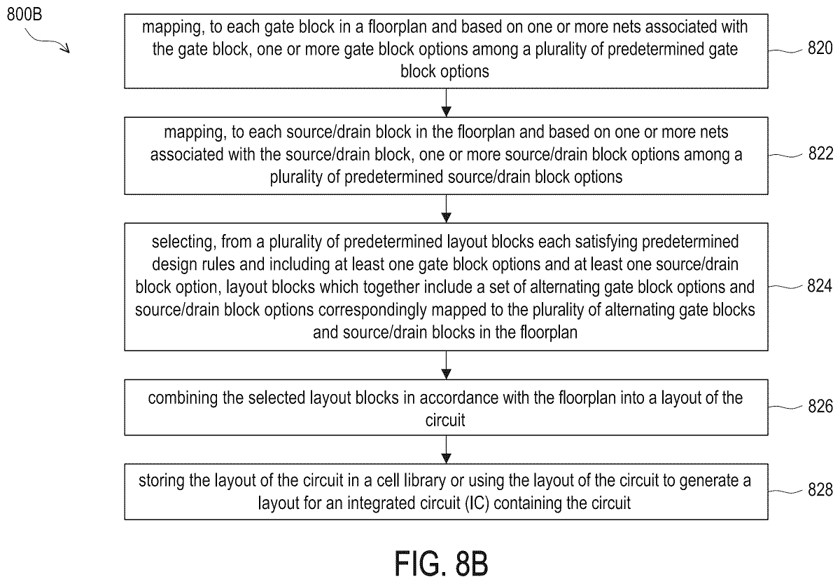

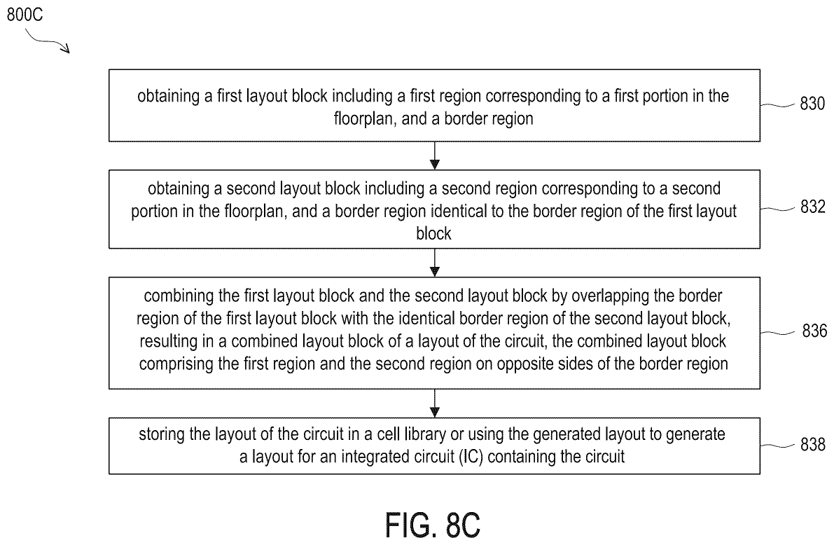

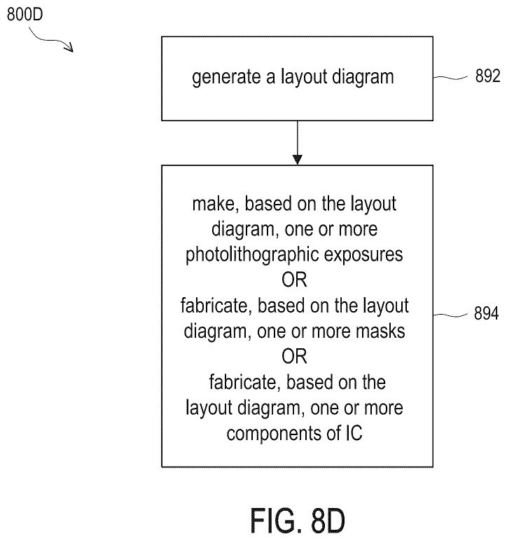

FIG. 8A is a flowchart of a method 800A of generating a layout of a circuit, in accordance with some embodiments. In at least one embodiment, method 800B is performed by at least one processor.

At operation 810, a plurality of different layout blocks is generated. Each layout block satisfies predetermined design rules and comprises at least one first block option associated with a first layout feature, and at least one second block option associated with a second layout feature. For example, as described with respect to FIGS. 4C, 4F, a plurality of different layout blocks, e.g., layout blocks 421, 422 in FIG. 4C, layout blocks 451, 452 in FIG. 4F is generated. Each layout block satisfies predetermined design rules, e.g., each layout block is DRC-free as described herein. Each layout block, e.g., layout block 421 in FIG. 4C, comprises at least one first block option, e.g., PO16, associated with a first layout feature, e.g., gate region, and at least one second block option, e.g., MD21 associated with a second layout feature, e.g., MD region. The described layout blocks are examples. A large number of layout blocks is generated, e.g., by combining at least 21 PO block options (FIG. 4A) and 28 MD block options (FIG. 4B). The number of layout blocks is further increased when at least one additional layout feature, e.g., CM0, is considered, as described with respect to FIGS. 4D-4F.

At operation 812, among the plurality of layout blocks, layout blocks corresponding to a plurality of blocks in a floorplan of the circuit are selected, for example, as described with respect to FIG. 5B.

At operation 816, the selected layout blocks are combined in accordance with the floorplan into a layout of the circuit, for example, as described with respect to FIGS. 5B-5D, 6, 7B-7D.

At operation 818, the layout of the circuit is stored in a cell library, e.g., in at least one library 133 in FIG. 1B, or used to generate a layout for an integrated circuit (IC) containing the circuit, e.g., as described with respect to operations 130-170 in FIG. 1B.

In some embodiments, the layout blocks generated at operation 810 include all possible and DRC-free layout blocks obtainable from the PO block options and MD block options. These layout blocks are stored, e.g., in the at least one library 133, for later use as predetermined blocks for building multiple layouts for various cells or circuits.

In some embodiments, operations 812, 816 correspond to generating a layout solution based on the floorplan of the circuit. In at least one embodiment, by repeatedly performing operations 812, 816, multiple, or all possible, layout solutions based on the floorplan of the circuit are generated, as described with respect to operation 135 in FIG. 1B. In at least one embodiment, one or more advantages described herein are achievable by the method 800A.

FIG. 8B is a flowchart of a method 800B of generating a layout of a circuit, in accordance with some embodiments. In at least one embodiment, method 800B is performed by at least one processor.

At operation 820, a first mapping is performed to map, to each gate block in a floorplan and based on one or more nets associated with the gate block, one or more gate block options among a plurality of predetermined gate block options. For example, as described with respect to FIG. 5B, one or more gate block options among the PO block options 400A (FIG. 4A) are mapped to each of gate blocks 372, 374, 376, 378 of the floorplan 300B, based on the nets associated with each of the gate blocks 372, 374, 376, 378.

At operation 822, a second mapping is performed to map, to each source/drain block in a floorplan and based on one or more nets associated with the source/drain block, one or more source/drain block options among a plurality of predetermined source/drain block options. For example, as described with respect to FIGS. 5A, 5B, one or more MD block options among the MD block options 400B (FIG. 4B) are mapped to each of source/drain blocks 371, 373, 375, 377, 379 of the floorplan 300B, based on the nets associated with each of the source/drain blocks 371, 373, 375, 377, 379.

At operation 824, from a plurality of predetermined layout blocks each satisfying predetermined design rules and including at least one gate block options and at least one source/drain block option, layout blocks are selected. The selected layout blocks together include a set of alternating gate block options and source/drain block options correspondingly mapped to the plurality of alternating gate blocks and source/drain blocks in the floorplan. For example, as described with respect to FIGS. 5B, 5D, various layout blocks 511-515, 521-525 are selected from a plurality of predetermined layout blocks to match the gate blocks and source/drain blocks in the floorplan.

At operation 826, the selected layout blocks are combined in accordance with the floorplan into a layout of the circuit, for example, as described with respect to FIGS. 5B-5D, 6, 7B-7D.

At operation 828, the layout of the circuit is stored in a cell library, e.g., in at least one library 133 in FIG. 1B, or used to generate a layout for an integrated circuit (IC) containing the circuit, e.g., as described with respect to operations 130-170 in FIG. 1B. In at least one embodiment, one or more advantages described herein are achievable by the method 800B.

FIG. 8C is a flowchart of a method 800C of generating a layout of a circuit, in accordance with some embodiments. In at least one embodiment, method 800C is performed by at least one processor.

At operation 830, a first layout block is obtained. The first layout block includes a first region corresponding to a first portion in the floorplan, and a border region. For example, as described with respect to FIG. 7C, a first layout block 721 including a first region A, B corresponding to a first portion in the floorplan, and a border region C, D (or 727).

At operation 832, a second layout block is obtained. The second layout block includes a second region corresponding to a second portion in the floorplan, and a border region identical to the border region of the first layout block. For example, as described with respect to FIG. 7C, a second layout block 725 including a second region E, F corresponding to a second portion in the floorplan, and a border region C, D identical to the border region of the first layout block 721.

At operation 836, the first layout block and the second layout block are combined by overlapping the border region of the first layout block with the identical border region of the second layout block, resulting in a combined layout block of a layout of the circuit. The combined layout block comprises the first region and the second region on opposite sides of the border region. For example, as described with respect to FIG. 7C, the first layout block 721 and the second layout block 725 are combined by overlapping the border region 727 of the first layout block 721 with the identical border region of the second layout block 725, resulting in a combined layout block 728 of a layout of the circuit. The combined layout block 728 comprises the first region A, B and the second region E, F on opposite sides of the border region C, D.

At operation 838, the layout of the circuit is stored in a cell library, e.g., in at least one library 133 in FIG. 1B, or used to generate a layout for an integrated circuit (IC) containing the circuit, e.g., as described with respect to operations 130-170 in FIG. 1B. In at least one embodiment, one or more advantages described herein are achievable by the method 800C.

FIG. 8D is a flowchart of a method 800D of manufacturing a semiconductor device or IC, in accordance with some embodiments.

Method 800D is implementable, for example, using EDA system 900 (FIG. 9, discussed below) and an integrated circuit (IC), manufacturing system 1000 (FIG. 10, discussed below), in accordance with some embodiments.

In FIG. 8D, method 800D includes operations 892, 894. At operation 892, a layout diagram is generated which, among other things, includes one or more of layouts for various circuits as disclosed herein, or the like. Operation 892 is implementable, for example, using EDA system 900 (FIG. 9, discussed below), in accordance with some embodiments. From operation 892, flow proceeds to operation 894.

At operation 894, based on the layout diagram, at least one of (A) one or more photolithographic exposures are made or (B) one or more semiconductor masks are fabricated or (C) one or more components in a layer of a semiconductor device are fabricated, as described herein below with respect to FIG. 10.

In at least one embodiment, one or more of the described operations are omitted. In at least one embodiment, one or more of the described operations are combined. In at least one embodiment, one or some or all of the described operations are automatically performed by at least one processor.

The described methods include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

In some embodiments, at least one method(s) discussed herein is performed in whole or in part by at least one EDA system. In some embodiments, an EDA system is usable as part of a design house of an IC manufacturing system discussed below.

FIG. 9 is a block diagram of an electronic design automation (EDA) system 900 in accordance with some embodiments.

In some embodiments, EDA system 900 includes an automatic placement and routing (APR) system. Methods described herein of designing layout diagrams represent wire routing arrangements, in accordance with one or more embodiments, are implementable, for example, using EDA system 900, in accordance with some embodiments.

In some embodiments, EDA system 900 is a general purpose computing device including a hardware processor 902 and a non-transitory, computer-readable storage medium 904. Storage medium 904, amongst other things, is encoded with, i.e., stores, computer program code 906, i.e., a set of executable instructions. Execution of instructions 906 by hardware processor 902 represents (at least in part) an EDA tool which implements a portion or all of the methods described herein in accordance with one or more embodiments (hereinafter, the noted processes and/or methods).

Processor 902 is electrically coupled to computer-readable storage medium 904 via a bus 908. Processor 902 is also electrically coupled to an I/O interface 910 by bus 908. A network interface 912 is also electrically connected to processor 902 via bus 908. Network interface 912 is connected to a network 914, so that processor 902 and computer-readable storage medium 904 are capable of connecting to external elements via network 914. Processor 902 is configured to execute computer program code 906 encoded in computer-readable storage medium 904 in order to cause system 900 to be usable for performing a portion or all of the noted processes and/or methods. In one or more embodiments, processor 902 is a central processing unit (CPU), a multi-processor, a distributed processing system, an application specific integrated circuit (ASIC), and/or a suitable processing unit.

In one or more embodiments, computer-readable storage medium 904 is an electronic, magnetic, optical, electromagnetic, infrared, and/or a semiconductor system (or apparatus or device). For example, computer-readable storage medium 904 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 904 includes a compact disk-read only memory (CD-ROM), a compact disk-read/write (CD-R/W), and/or a digital video disc (DVD).

In one or more embodiments, storage medium 904 stores computer program code 906 configured to cause system 900 (where such execution represents (at least in part) the EDA tool) to be usable for performing a portion or all of the noted processes and/or methods. In one or more embodiments, storage medium 904 also stores information which facilitates performing a portion or all of the noted processes and/or methods. In one or more embodiments, storage medium 904 stores library 907 of standard cells including such standard cells as disclosed herein. In one or more embodiments, storage medium 904 stores one or more layout diagrams disclosed herein.

EDA system 900 includes I/O interface 910. I/O interface 910 is coupled to external circuitry. In one or more embodiments, I/O interface 910 includes a keyboard, keypad, mouse, trackball, trackpad, touchscreen, and/or cursor direction keys for communicating information and commands to processor 902.

EDA system 900 also includes network interface 912 coupled to processor 902. Network interface 912 allows system 900 to communicate with network 914, to which one or more other computer systems are connected. Network interface 912 includes wireless network interfaces such as BLUETOOTH, WIFI, WIMAX, GPRS, or WCDMA; or wired network interfaces such as ETHERNET, USB, or IEEE-2164. In one or more embodiments, a portion or all of noted processes and/or methods, is implemented in two or more systems 900.

System 900 is configured to receive information through I/O interface 910. The information received through I/O interface 910 includes one or more of instructions, data, design rules, libraries of standard cells, and/or other parameters for processing by processor 902. The information is transferred to processor 902 via bus 908. EDA system 900 is configured to receive information related to a UI through I/O interface 910. The information is stored in computer-readable medium 904 as user interface (UI) 942.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 900. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 10 is a block diagram of an integrated circuit (IC) manufacturing system 1000, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1000.

In FIG. 10, IC manufacturing system 1000 includes entities, such as a design house 1020, a mask house 1030, and an IC manufacturer/fabricator (fab) 1050, that interact with one another in the design, development, and manufacturing cycles and/or services related to manufacturing an IC 1060. The entities in system 1000 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1020, mask house 1030, and IC fab 1050 is owned by a single larger company. In some embodiments, two or more of design house 1020, mask house 1030, and IC fab 1050 coexist in a common facility and use common resources.

Design house (or design team) 1020 generates an IC design layout diagram 1022. IC design layout diagram 1022 includes various geometrical patterns designed for an IC 1060. The geometrical patterns correspond to patterns of metal, oxide, or semiconductor layers that make up the various components of IC 1060 to be fabricated. The various layers combine to form various IC features. For example, a portion of IC design layout diagram 1022 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1020 implements a proper design procedure to form IC design layout diagram 1022. The design procedure includes one or more of logic design, physical design or place and route. IC design layout diagram 1022 is presented in one or more data files having information of the geometrical patterns. For example, IC design layout diagram 1022 can be expressed in a GDSII file format or DFII file format.

Mask house 1030 includes data preparation 1032 and mask fabrication 1044. Mask house 1030 uses IC design layout diagram 1022 to manufacture one or more masks 1045 to be used for fabricating the various layers of IC 1060 according to IC design layout diagram 1022. Mask house 1030 performs mask data preparation 1032, where IC design layout diagram 1022 is translated into a representative data file (RDF). Mask data preparation 1032 provides the RDF to mask fabrication 1044. Mask fabrication 1044 includes a mask writer. A mask writer converts the RDF to an image on a substrate, such as a mask (reticle) 1045 or a semiconductor wafer 1053. The design layout diagram 1022 is manipulated by mask data preparation 1032 to comply with particular characteristics of the mask writer and/or requirements of IC fab 1050. In FIG. 10, mask data preparation 1032 and mask fabrication 1044 are illustrated as separate elements. In some embodiments, mask data preparation 1032 and mask fabrication 1044 can be collectively referred to as mask data preparation.

In some embodiments, mask data preparation 1032 includes optical proximity correction (OPC) which uses lithography enhancement techniques to compensate for image errors, such as those that can arise from diffraction, interference, other process effects and the like. OPC adjusts IC design layout diagram 1022. In some embodiments, mask data preparation 1032 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1032 includes a mask rule checker (MRC) that checks the IC design layout diagram 1022 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1022 to compensate for photolithographic implementation effects during mask fabrication 1044, which may undo part of the modifications performed by OPC in order to meet mask creation rules.

In some embodiments, mask data preparation 1032 includes lithography process checking (LPC) that simulates processing that will be implemented by IC fab 1050 to fabricate IC 1060. LPC simulates this processing based on IC design layout diagram 1022 to create a simulated manufactured device, such as IC 1060. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1022.

It should be understood that the above description of mask data preparation 1032 has been simplified for the purposes of clarity. In some embodiments, data preparation 1032 includes additional features such as a logic operation (LOP) to modify the IC design layout diagram 1022 according to manufacturing rules. Additionally, the processes applied to IC design layout diagram 1022 during data preparation 1032 may be executed in a variety of different orders.

After mask data preparation 1032 and during mask fabrication 1044, a mask 1045 or a group of masks 1045 are fabricated based on the modified IC design layout diagram 1022. In some embodiments, mask fabrication 1044 includes performing one or more lithographic exposures based on IC design layout diagram 1022. In some embodiments, an electron-beam (e-beam) or a mechanism of multiple e-beams is used to form a pattern on a mask (photomask or reticle) 1045 based on the modified IC design layout diagram 1022. Mask 1045 can be formed in various technologies. In some embodiments, mask 1045 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1045 includes a transparent substrate (e.g., fused quartz) and an opaque material (e.g., chromium) coated in the opaque regions of the binary mask. In another example, mask 1045 is formed using a phase shift technology. In a phase shift mask (PSM) version of mask 1045, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1044 is used in a variety of processes. For example, such a mask(s) is used in an ion implantation process to form various doped regions in semiconductor wafer 1053, in an etching process to form various etching regions in semiconductor wafer 1053, and/or in other suitable processes.

IC fab 1050 is an IC fabrication business that includes one or more manufacturing facilities for the fabrication of a variety of different IC products. In some embodiments, IC Fab 1050 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1050 includes fabrication tools 1052 configured to execute various manufacturing operations on semiconductor wafer 1053 such that IC 1060 is fabricated in accordance with the mask(s), e.g., mask 1045. In various embodiments, fabrication tools 1052 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1050 uses mask(s) 1045 fabricated by mask house 1030 to fabricate IC 1060. Thus, IC fab 1050 at least indirectly uses IC design layout diagram 1022 to fabricate IC 1060. In some embodiments, semiconductor wafer 1053 is fabricated by IC fab 1050 using mask(s) 1045 to form IC 1060. In some embodiments, the IC fabrication includes performing one or more lithographic exposures based at least indirectly on IC design layout diagram 1022. Semiconductor wafer 1053 includes a silicon substrate or other proper substrate having material layers formed thereon. Semiconductor wafer 1053 further includes one or more of various doped regions, dielectric features, multilevel interconnects, and the like (formed at subsequent manufacturing steps).

In some embodiments, a system comprises a processor, and a non-transitory computer readable storage medium connected to the processor, wherein the processor is configured to execute instructions stored on the computer readable storage medium. The processor is configured to perform generating a plurality of different layout blocks, selecting, among the plurality of layout blocks, layout blocks corresponding to a plurality of blocks in a floorplan of a circuit, combining the selected layout blocks in accordance with the floorplan into a layout of the circuit, and storing the layout of the circuit in a cell library or using the layout of the circuit to generate a layout for an integrated circuit (IC) containing the circuit. Each of the plurality of layout blocks satisfies predetermined design rules and comprises at least one of a plurality of different first block options associated with a first layout feature, and at least one of a plurality of different second block options associated with a second layout feature different from the first layout feature.

In some embodiments, a method of generating layouts for a circuit in accordance with a floorplan of the circuit is performed at least partially by a processor. The floorplan comprises a plurality of nets associated with a plurality of alternating gate blocks and source/drain blocks. The method comprises first mapping, to each gate block in the floorplan and based on one or more nets associated with the gate block, one or more gate block options among a plurality of predetermined gate block options. The method further comprises second mapping, to each source/drain block in the floorplan and based on one or more nets associated with the source/drain block, one or more source/drain block options among a plurality of predetermined source/drain block options. The method further comprises selecting, from a plurality of predetermined layout blocks each satisfying predetermined design rules and including at least one of the plurality of predetermined gate block options and at least one of the plurality of predetermined source/drain block options, layout blocks which together include a set of alternating gate block options and source/drain block options correspondingly mapped, by said first mapping and second mapping, to the plurality of alternating gate blocks and source/drain blocks in the floorplan. The method further comprises combining the selected layout blocks in accordance with the floorplan into a layout of the circuit; and storing the layout of the circuit in a cell library or using the layout of the circuit to generate a layout for an integrated circuit (IC) containing the circuit.

In some embodiments, a computer program product comprises a non-transitory, computer-readable medium containing instructions therein. The instructions, when executed, cause the processor to perform generating a layout of a circuit in accordance with a floorplan of the circuit; and storing the generated layout in a cell library or using the generated layout to generate a layout for an integrated circuit (IC) containing the circuit. The generating the layout comprises obtaining a first layout block and a second layout block. The first layout block includes a first region corresponding to a first portion in the floorplan, and a border region. The second layout block includes a second region corresponding to a second portion in the floorplan, and a border region identical to the border region of the first layout block. The generating the layout further comprises combining the first layout block and the second layout block by overlapping the border region of the first layout block with the identical border region of the second layout block, resulting in a combined layout block of the layout of the circuit. The combined layout block comprises the first region and the second region on opposite sides of the border region.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a processor; and
a non-transitory computer readable storage medium coupled to the processor, wherein the processor is configured to execute instructions stored on the computer readable storage medium to perform:
generating a plurality of different layout blocks, each satisfying predetermined design rules and comprising:
at least one of a plurality of different first block options associated with a first layout feature, and
at least one of a plurality of different second block options associated with a second layout feature different from the first layout feature,
selecting, among the plurality of layout blocks, layout blocks corresponding to a plurality of blocks in a floorplan of a circuit,
combining the selected layout blocks in accordance with the floorplan into a layout of the circuit, and
storing the layout of the circuit in a cell library or using the layout of the circuit to generate a layout for an integrated circuit (IC) containing the circuit.

2. The system of claim 1, wherein
the processor is further configured to execute the instructions stored on the computer readable storage medium to:
repeatedly perform said selecting and said combining to generate multiple, different layouts of the circuit, and
save the multiple, different layouts of the circuit in the cell library.

3. The system of claim 1, wherein
the processor is further configured to execute the instructions stored on the computer readable storage medium to:
perform an exhaustive search, in which said selecting and said combining are repeatedly performed, to generate all possible layouts of the circuit, and
save the all possible layouts of the circuit in the cell library.

4. The system of claim 1, wherein
the processor is further configured to execute the instructions stored on the computer readable storage medium to:
execute a Depth-First-Search (DFS) algorithm, in which said selecting and said combining are repeatedly performed, to generate multiple, different layouts of the circuit, and
save the multiple, different layouts of the circuit in the cell library.

5. The system of claim 1, wherein
the processor is further configured to execute the instructions stored on the computer readable storage medium to combine two layout blocks among the selected layout blocks by
abutting the two layout blocks, or
overlapping the two layout blocks in an identical border region of the two layout blocks.

6. The system of claim 1, wherein
the first layout feature is a gate region, and
the second layout feature is a source/drain contact region.

7. The system of claim 1, wherein
the processor is further configured to execute the instructions stored on the computer readable storage medium to generate the plurality of first block options each of which is
a gate region, or
a combination of the gate region with at least one of
at least one cut region configured to cut or disable a portion of the gate region, or
at least one first via over the gate region.

8. The system of claim 1, wherein
the processor is further configured to execute the instructions stored on the computer readable storage medium to generate the plurality of second block options each of which is
a source/drain contact region, or
a combination of the source/drain contact region with at least one of
at least one cut region configured to cut a portion of the source/drain contact region, or
at least one second via over the source/drain contact region.

9. The system of claim 1, wherein
the processor is further configured to execute the instructions stored on the computer readable storage medium to
generate the plurality of different layout blocks, each satisfying the predetermined design rules and further comprising:
at least one of a plurality of different third block options associated with a third layout feature different from the first layout feature and the second layout feature.

10. The system of claim 9, wherein
the processor is further configured to execute the instructions stored on the computer readable storage medium to
generate the plurality of third block options each of which comprises at least one cut region configured to cut a portion of a conductive pattern in a metal layer.

11. A method of generating layouts for a circuit in accordance with a floorplan of the circuit, the floorplan comprising a plurality of nets associated with a plurality of alternating gate blocks and source/drain blocks, said method performed at least partially by a processor and comprising:
first mapping, to each gate block in the floorplan and based on one or more nets associated with the gate block, one or more gate block options among a plurality of predetermined gate block options;
second mapping, to each source/drain block in the floorplan and based on one or more nets associated with the source/drain block, one or more source/drain block options among a plurality of predetermined source/drain block options;
selecting, from a plurality of predetermined layout blocks each satisfying predetermined design rules and including at least one of the plurality of predetermined gate block options and at least one of the plurality of predetermined source/drain block options, layout blocks which together include a set of alternating gate block options and source/drain block options correspondingly mapped, by said first mapping and second mapping, to the plurality of alternating gate blocks and source/drain blocks in the floorplan;
combining the selected layout blocks in accordance with the floorplan into a layout of the circuit; and
storing the layout of the circuit in a cell library or using the layout of the circuit to generate a layout for an integrated circuit (IC) containing the circuit.

12. The method of claim 11, wherein
first mapping and second mapping are further based on predetermined layout-versus-schematic (LVS) rules.

13. The method of claim 11, wherein
each of the plurality of predetermined gate block options is
a gate region, or
a combination of the gate region with at least one of
at least one first cut region configured to cut or disable a portion of the gate region,
at least one first via over the gate region, or
at least one second cut region over the gate region, and configured to cut a portion of a conductive pattern in a metal layer.

14. The method of claim 11, wherein
each of the plurality of predetermined source/drain block options is
a source/drain contact region, or
a combination of the source/drain contact region with at least one of
at least one first cut region configured to cut a portion of the source/drain contact region,
at least one via over the source/drain contact region, or
at least one second cut region over the source/drain contact region, and configured to cut a portion of a conductive pattern in a metal layer.

15. The method of claim 11, wherein
each of the plurality of predetermined gate block options satisfies the predetermined design rules, and
each of the plurality of predetermined source/drain block options satisfies the predetermined design rules.

16. A computer program product, comprising a non-transitory, computer-readable medium containing instructions therein which, when executed by a processor, cause the processor to perform:
generating a layout of a circuit in accordance with a floorplan of the circuit; and
storing the generated layout in a cell library or using the generated layout to generate a layout for an integrated circuit (IC) containing the circuit,
wherein said generating the layout comprises:
obtaining a first layout block and a second layout block,
the first layout block including:
a first region corresponding to a first portion in the floorplan, and
a border region, and
the second layout block including:
a second region corresponding to a second portion in the floorplan, and
a border region identical to the border region of the first layout block; and
combining the first layout block and the second layout block by overlapping the border region of the first layout block with the identical border region of the second layout block, resulting in a combined layout block of the layout of the circuit,
wherein the combined layout block comprises the first region and the second region on opposite sides of the border region.

17. The computer program product of claim 16, wherein
the border region corresponds to a third portion in the floorplan,
the third portion is between and contiguous to the first portion and the second portion in the floorplan, and
the border region is between and contiguous to the first region and the second region in the combined layout block of the layout of the circuit.

18. The computer program product of claim 16, wherein
said obtaining the first layout block and the second layout block comprises:
selecting at least one of the first layout block or the second layout block among a plurality of predetermined different layout blocks each satisfying predetermined design rules.

19. The computer program product of claim 16, wherein
said obtaining the first layout block and the second layout block comprises:
selecting, among a plurality of predetermined different layout blocks each satisfying predetermined design rules, the second layout block such that the second region includes a further border region of the second layout block and is identical to a further border region of a third layout block,
the third layout block further comprises a third region corresponding to a third portion in the floorplan, and
said generating the layout further comprises:
combining the combined layout block and the third layout block by overlapping the further border region of the second layout block with the identical further border region of the third layout block, resulting in a further combined layout block of the layout of the circuit,
wherein the further combined layout block comprises the second region and the third region on opposite sides of the further border region.

20. The computer program product of claim 19, wherein
the border region corresponds to a fourth portion in the floorplan,
the first portion, fourth portion, second portion and the third portion are contiguous to each other in the floorplan, and
the first region, the border region, the second region and the third region and contiguous to each other in the further combined layout block of the layout of the circuit.
